(19) United States
(12) Patent Application Publication
(10) Pub. No.: US 2026/0203725 A1
(43) Pub. Date: Jul. 16, 2026

(54) WASTE MANAGEMENT EQUIPMENT MONITORING, DIAGNOSTIC, AND PREDICTIVE MAINTENANCE SYSTEM

(71) Applicant: GOCO CONSTRUCTION WASTE MANAGEMENT , INC., BLUE RIDGE, GA (US)

(72) Inventor: JOSH GOLDEN, BLUE RIDGE, GA (US)

(73) Assignee: GOCO CONSTRUCTIOON WASTE MANAGEMENT, INC, BLUE RIDGE, GA (US)

(21) Appl. No.: 19/449,048

(22) Filed: Jan. 14, 2026

Related U.S. Application Data
(60) Provisional application No. 63/745,766, filed on Jan. 15, 2025.

(51) Int. Cl. G06Q 10/20; G05B 13/02; G06Q 10/30

(52) U.S. Cl. CPC G06Q 10/20; G05B 13/027; G06Q 10/30

(57) ABSTRACT

A monitoring and control system is provided for commercial waste compaction equipment that integrates distributed sensor hardware, local control hardware, and remote computing resources to manage equipment health, safety, and capacity. Each waste compactor includes sensors such as hydraulic pressure, electrical current, temperature, vibration, door position, weight, fill level, and thermal imaging, coupled to a programmable controller and an edge computing device that digitizes, buffers, and pre-processes time-series sensor data. A communication gateway transmits processed sensor data to a remote computing platform that stores time-series data, executes diagnostic and predictive maintenance processing, performs thermal image analysis for hazardous material and fire-risk detection, and computes projected fill levels to generate control outputs and service commands. The remote platform returns control and configuration signals used by the local controller to adjust operating parameters, place equipment into safe states, and coordinate service and hauling operations across multiple units.

### CROSS-REFERENCE

This application claims the benefit of U.S. Provisional Application No. 63/745,766, filed Jan. 15, 2025, entitled “AUTOMATED INVERSE POP/POS SYSTEM FOR A COMMERCIAL TRASH COMPACTOR SYSTEM,” which is incorporated by reference in its entirety.

This application is related to U.S. patent application Ser. No. 19/445,510, filed Jan. 10, 2026, entitled “CLOUD-INTEGRATED AUTONOMOUS WASTE COMPACTION SYSTEM WITH AUTOMATED ACCESS CONTROL,” which is incorporated herein by reference in its entirety.

### FIELD

The present disclosure relates to waste management equipment monitoring and diagnostic systems, and more particularly to a cloud-integrated system for real-time monitoring, automated diagnostics, predictive maintenance, hazardous material detection, and operational optimization of commercial waste compaction equipment through continuous sensor data processing that generates diagnostic outputs and control signals used to automatically manage operation, safety, and initiate maintenance or modify equipment operation of commercial waste compaction equipment.

### BACKGROUND

### Technical Problem

Commercial waste compaction equipment operates in demanding environments with frequent mechanical cycling and exposure to diverse waste materials. Equipment failures result in operational downtime, service call costs, and lost revenue. Traditional maintenance approaches rely on fixed time schedules or reactive repairs after equipment failure.

Operators lack real-time visibility into equipment condition and cannot predict when failures will occur. Without continuous monitoring, small problems escalate into major failures. By the time equipment stops functioning, significant downtime and costs have already occurred.

Hence, commercial waste compaction requires a comprehensive system that: Continuously monitors equipment subsystems through integrated sensor arrays; Detects equipment faults through sensor data pattern analysis; Predicts failures before they occur based on measured degradation; Prevents fire hazards through thermal monitoring and immediate shutdown; Optimizes service scheduling through fill level predictions; and Provides fleet visibility across multiple distributed equipment units.

Thus, there exists a need for a comprehensive monitoring and diagnostic system specifically designed for commercial waste compaction equipment that integrates: (a) real-time monitoring of multiple equipment subsystems including hydraulic systems, electrical systems, sensors, and mechanical components; (b) automated diagnostic algorithms that detect equipment faults and anomalies through analysis of sensor data patterns; (c) predictive maintenance algorithms that forecast equipment failures before they occur based on degradation patterns; (d) thermal imaging analysis for detecting hazardous materials and preventing fire hazards; (e) fill level prediction algorithms for optimizing waste hauling logistics; (f) integration with operational data including transactions, usage patterns, and environmental conditions to provide comprehensive equipment analytics; and (g) cloud-based platform enabling remote monitoring, fleet management, and data-driven operational optimization.

### SUMMARY

Disclosed herein is a waste management equipment monitoring, diagnostic, and predictive maintenance system that overcomes deficiencies of prior art by providing comprehensive real-time monitoring, automated diagnostics, predictive maintenance, hazardous material detection, and operational optimization that generates diagnostic outputs and control signals used to automatically manage operation, safety, and initiate maintenance or modify equipment operation of commercial waste compaction equipment specifically designed for commercial waste compaction equipment.

Disclosed herein is an integrated hardware and software system for waste management equipment monitoring, diagnostics, and maintenance scheduling. The system combines physical sensors, edge computing hardware, and cloud-based data processing to continuously assess equipment condition and predict failures.

The system comprises: Edge Hardware: Sensor arrays, data acquisition boards, local processing units, and communication interfaces mounted on or integrated with waste compaction equipment; Cloud Services: Data processing, storage, and user interface services operating on server computers; and Communication Infrastructure: Network devices enabling secure data transmission between equipment and cloud services.

Advantages and key features include real-time equipment monitoring such as: Hydraulic pressure sensors to measure ram cylinder pressure during compaction cycles; Electrical current sensors to monitor motor and actuator power consumption; Temperature sensors to measure hydraulic fluid and component temperatures; Position sensors to track door and actuator status; Weight sensors to measure deposited waste quantities; Fill level sensors to detect accumulated waste height; Thermal imaging cameras to view receiving bins for thermal anomalies; and Video cameras to provide visual documentation.

Each waste compaction system continuously collects sensor data at appropriate sampling rates. The edge computing hardware buffers this data and transmits it to cloud services at intervals optimized for data freshness and communication efficiency.

### Equipment Fault Detection

The system implements specialized diagnostic modules that analyze sensor data patterns such as:
1. A Hydraulic Diagnostic Module which Measures hydraulic pressure profiles during each compaction cycle; Calculates statistical metrics: maximum pressure, mean pressure, pressure variance, pressure rise rate, cycle duration; Compares current metrics to baseline metrics established during initial operation; and Detects deviations indicating fault conditions such as: Hydraulic fluid leaks: Progressive decline in maximum pressure and pressure rise rate over many cycles; Pump degradation: Declining pressure rise rate with stable maximum pressure; Cylinder seal wear: Increased pressure variance during compaction phases; Line blockage: Abnormally high maximum pressure combined with slow pressure rise.
2. An Electrical Diagnostic Module which measures electrical current draw of hydraulic pump motors during operation; Compares current measurements to expected ranges for known load conditions; and Detects deviations indicating: motor bearing wear: Elevated baseline current draw; Electrical connection issues: Current fluctuations at non-standard frequencies; Actuator mechanical binding: Elevated current during door actuation; and Electrical failures: No current draw when commanded to activate.
3. A Mechanical Diagnostic Module which; Measures vibration levels on hydraulic pumps, motors, and structural components; Detects changes in vibration frequency patterns indicating bearing defects; and Identifies mechanical looseness and imbalance conditions.
4. A Thermal Hazard Detection Module which; Continuously receives thermal image data from infrared cameras; Processes thermal images to identify localized hot spots within waste receiving area; Classifies thermal signatures by temperature: a.) Normal (<130° F.): ambient or warm waste; b.) Elevated (130-200° F.): concerning thermal activity; c.) Critical (>200° F.): fire hazard conditions: Tracks thermal signatures across sequential images to assess temporal characteristics: d.) Transient: appears and disappears quickly (<5 seconds); e.) Persistent: remains for extended period without growth; f.) Growing: increases in size or temperature over time; Generates alerts when persistent or growing thermal signatures are detected; and Transmits control commands to immediately disable access and activate fire suppression systems if critical thermal conditions detected.
5. An Equipment Failure Prediction for components showing degradation patterns, the system performs trending analysis: Collects historical measurements of key metrics (hydraulic pressure, motor current, vibration, thermal patterns); Identifies degradation trends in the collected measurements using linear, polynomial, or exponential fitting; Calculates time-to-failure by determining when the degradation trend will reach a defined failure threshold; Generates maintenance recommendations specifying which components require service and the estimated time remaining before failure.

Example: If hydraulic maximum pressure declines at −10 PSI per day, and the failure threshold is 1500 PSI (below which effective compaction is impossible), and current pressure is 2200 PSI, the system calculates that failure will occur in approximately 70 days. The system generates a maintenance recommendation to service the hydraulic system within 50 days (at 75% of calculated RUL) to ensure service occurs before failure.
6. Fill Level Prediction and Service Optimization which Analyzes transaction history to calculate average waste deposit rate as a function of time of day and day of week; Measures current fill level using fill level sensors; Calculates fill rate based on recent waste deposits and current fill sensor data; Adjusts fill rate based on predicted future usage patterns derived from historical patterns (e.g., if currently in a high-usage period of day); Predicts time to full capacity by dividing remaining capacity by adjusted fill rate; Generates service dispatch recommendations when predicted time-to-full is less than the service vehicle dispatch lead time; and Transmits recommendations to waste hauling service provider systems to enable advance scheduling.

Example: Equipment at location X is 65% full with a measured fill rate of 10% per day. Remaining capacity is 35%. Predicted time to full is 3.5 days. If service dispatch lead time is 2 days, the system generates a service dispatch recommendation immediately, enabling the service provider to schedule a collection visit before the equipment reaches full capacity.
7. Fleet Management and Visualization wherein the system provides a comprehensive fleet management interface: Map Visualization: Geographic map showing locations of all deployed waste compaction systems with status color-coding: g.) Green: Operational, no known issues; h.) Yellow: Service needed soon (maintenance recommendation issued); j.) Red: Urgent service required (critical fault detected); k.) Gray: Offline or not communicating; Status Indicators: Clickable equipment units displaying real-time information including sensor data, active alerts, fill level, and maintenance history; Comparative Analytics: Aggregates operational metrics across fleet including average uptime, total revenue, cycle frequency, and mean time between failures; identifies equipment units deviating significantly from fleet averages; Maintenance Coordination: Consolidates service recommendations by geographic proximity to optimize service vehicle routing; generates technician work assignments; and Optimization Reports: Analyzes geographic distribution and usage patterns to identify underserved locations and recommend expansion or relocation of equipment units.

Additionally, disclosed herein are systems, methods, and non-transitory computer-readable media for operating an autonomous waste handling system that uses POP/POS authorization to grant a user a plurality of access cycles during a single paid session. In embodiments, a controller (e.g., a PLC) unlocks an access door after receiving an authorization signal, stores an authorized cycle count, tracks completed door cycles, and relocks the access door when the authorized cycle count is reached or upon early completion.

In some embodiments, the autonomous waste handling system is coupled to, or integrated with, a commercial waste compactor having a compaction chamber and ram actuator, and the controller optionally initiates compaction based on capacity indicators while maintaining required safety interlocks. In embodiments, the system further includes cloud communication for transaction reporting, diagnostics, configuration, notifications, and optional remote administration

In one aspect, provided herein is a computer-implemented system for monitoring and diagnosing waste compaction equipment comprising: a digital processing device comprising an operating system configured to perform executable instructions and a memory device; a computer program stored in the memory device and including instructions executable by the digital processing device to create a monitoring and diagnostic application comprising: a sensor data acquisition module configured to receive, via a network interface, real-time sensor data from a waste compaction system, said sensor data comprising hydraulic pressure measurements from pressure sensors monitoring a hydraulic ram actuator, electrical current measurements from current sensors monitoring motors and actuators, temperature measurements from thermal sensors, door position data from door position sensors, weight measurements from weight sensors, fill level measurements from fill level sensors, and video data from cameras; a hydraulic system diagnostic module configured to: analyze hydraulic pressure patterns over multiple compaction cycles; calculate statistical metrics including mean pressure, pressure variance, maximum pressure, and pressure rise rate for each compaction cycle; detect pressure anomalies by comparing current cycle metrics to historical baseline metrics; identify hydraulic system faults selected from the group consisting of: hydraulic fluid leaks indicated by declining maximum pressure over time, pump degradation indicated by reduced pressure rise rate, cylinder seal wear indicated by increased pressure variance, and hydraulic line blockages indicated by abnormally high maximum pressure and to automatically generate a diagnostic control output used to initiate maintenance or modify equipment operation; an electrical system diagnostic module configured to: monitor electrical current draw of motors and actuators during operation; detect electrical anomalies by comparing current measurements to expected current ranges for specific operations; identify electrical system faults selected from the group consisting of: motor bearing wear indicated by increased current draw, electrical connection issues indicated by current fluctuations, and actuator mechanical binding indicated by elevated current during actuation; a predictive maintenance module configured to: extrapolate degradation trends from historical and real-time sensor data to generate maintenance timing signals consumed by the system to initiate maintenance actions or adjust equipment operating parameters, and to generate predictive maintenance recommendations specifying components requiring service and estimated time until failure; calculate remaining useful life estimates for components based on degradation trends and failure thresholds; generate predictive maintenance recommendations specifying components requiring service and estimated time until failure; a notification generation module configured to: evaluate sensor data, diagnostic results, and predictive maintenance recommendations against predefined alert criteria; generate alert notifications when alert criteria are met, said alert notifications comprising fault descriptions, severity levels, affected components, recommended actions, and timestamps; transmit alert notifications to operator devices via communication channels selected from the group consisting of: email, SMS, push notifications to mobile applications, and automated phone calls; and a data storage module configured to store sensor data, diagnostic results, predictive maintenance recommendations, and alert notifications in a database for historical analysis and reporting; wherein the monitoring and diagnostic application continuously processes real-time sensor data to enable proactive equipment maintenance reducing unplanned downtime.

In some embodiments, the hydraulic system diagnostic module is further configured to: perform linear regression on maximum pressure values over a sliding time window comprising a plurality of recent compaction cycles; calculate a degradation rate as a slope of the linear regression; determine that a hydraulic fluid leak exists when the degradation rate is negative and exceeds a threshold leak rate; and calculate an estimated time until hydraulic pressure becomes insufficient for compaction by extrapolating the linear regression to a failure pressure threshold.

In some embodiments, extracting statistical metrics for each compaction cycle comprises: identifying a ram extension phase during which hydraulic pressure rises from baseline to maximum; calculating pressure rise rate as a maximum rate of pressure increase during the ram extension phase; identifying a compaction phase during which the hydraulic ram compresses waste; calculating mean pressure and pressure variance during the compaction phase; and recording maximum pressure as a peak pressure value achieved during the compaction cycle.

In some embodiments, identifying hydraulic system faults comprises: correlating multiple statistical metrics exhibiting simultaneous anomalies to specific fault conditions; wherein hydraulic fluid leaks are identified by simultaneous detection of declining maximum pressure and declining pressure rise rate; wherein pump degradation is identified by detecting declining pressure rise rate without proportional decline in maximum pressure; and wherein cylinder seal wear is identified by detecting increased pressure variance while maximum pressure remains within baseline ranges.

In some embodiments, the predictive maintenance module is configured to: select a regression method executed by a processor from the group consisting of: linear regression, polynomial regression, and exponential regression, based on degradation pattern characteristics; calculate a goodness-of-fit metric indicating how well the regression method executed by a processor models observed degradation; and assign a confidence level to remaining useful life estimates based on the goodness-of-fit metric and quantity of historical data.

In some embodiments, the predictive maintenance module is configured to: identify a plurality of components each requiring service with respective remaining useful life estimates; rank the components by remaining useful life from shortest to longest; identify components having remaining useful life estimates within a consolidation threshold indicating service can be consolidated into a single maintenance visit; generate a consolidated maintenance recommendation specifying multiple components to be serviced during a single visit; and transmit the consolidated maintenance recommendation with estimated total labor hours and parts costs.

In some embodiments, the computer-implemented system for monitoring and diagnosing waste compaction equipment further comprises: a thermal monitoring module configured to: receive thermal image data from an infrared thermal imaging camera positioned to view a waste receiving area of the waste compaction system; identify localized thermal signatures within the thermal image data exhibiting temperatures exceeding a temperature threshold; track thermal signatures across sequential thermal images over time; classify thermal signatures as transient, persistent, or growing based on temporal persistence and spatial or thermal growth characteristics; generate hazardous material alerts for thermal signatures classified as persistent or growing; and transmit control commands to the waste compaction system to disable access control functionality responsive to detecting growing thermal signatures classified as critical.

In some embodiments, the computer-implemented system for monitoring and diagnosing waste compaction equipment further comprises: a fill level prediction module configured to: analyze historical transaction records and fill level measurements to extract usage patterns comprising transaction frequency as a function of time of day and day of week; calculate a current fill rate based on recent fill level changes and recent transaction counts; adjust the current fill rate based on predicted future usage patterns derived from the usage patterns; calculate a predicted time to full capacity and automatically transmit a service dispatch command to a waste hauling service provider system when the predicted time is below a dispatch threshold to a waste hauling service provider system.

This aspect provides advantages over prior art including: specific diagnostic algorithms for hydraulic compaction systems not disclosed in any prior art; predictive maintenance based on compaction-specific degradation patterns not disclosed in general-purpose monitoring systems like the '168 patent; integration of multiple sensor types providing comprehensive equipment health assessment; and automated alert generation with actionable maintenance recommendations enabling proactive rather than reactive maintenance.

In another aspect, provided herein is a computer-implemented system for thermal hazard detection in waste handling equipment comprising: a digital processing device comprising a processor and a memory; a computer program including instructions executable by the processor to create a thermal monitoring application comprising: a thermal image acquisition module configured to receive thermal image data from an infrared thermal imaging camera positioned to view a waste receiving area of a waste compaction system; a thermal signature analysis module configured to: process the thermal image data to identify localized thermal signatures within the waste receiving area; calculate temperature values for identified thermal signatures; compare temperature values to a temperature threshold corresponding to fire hazard conditions; classify thermal signatures as: normal if temperature values are below the temperature threshold; elevated if temperature values are between the temperature threshold and a critical threshold; or critical if temperature values exceed the critical threshold; a temporal analysis module configured to: track thermal signatures across sequential thermal images over time; detect thermal signature persistence when a thermal signature at a specific location persists across multiple sequential thermal images; detect thermal signature growth when a thermal signature expands in spatial extent or increases in temperature over time; classify thermal events as: transient if thermal signature does not persist beyond a time threshold; persistent if thermal signature persists beyond the time threshold without growth; or growing if thermal signature exhibits growth characteristics; a hazard alert module configured to: generate hazardous material alerts when thermal signatures are classified as elevated or critical; determine alert severity based on thermal signature classification and temporal analysis classification; transmit hazardous material alerts to monitoring personnel with alert severity, temperature measurements, thermal image data, timestamp, and equipment location; and a control interface module configured to: transmit control commands to the waste compaction system responsive to thermal hazard detection; wherein control commands comprise: disabling access control systems to prevent additional waste deposition when critical thermal signatures are detected; activating fire suppression systems when growing thermal signatures exceed the critical threshold; and activating ventilation systems to reduce heat buildup; wherein the thermal monitoring application enables detection and mitigation of fire hazards before ignition occurs.

In some embodiments, the thermal signature analysis module is configured to: calculate a background temperature representing an average temperature of non-waste regions within the thermal image data; subtract the background temperature from all pixels in the thermal image data to generate background-subtracted thermal image data; identify pixels in the background-subtracted thermal image data exceeding a differential temperature threshold; perform connected component analysis to group adjacent pixels exceeding the differential temperature threshold into contiguous regions representing thermal signatures; and characterize each thermal signature by: centroid location coordinates, spatial extent area, bounding box dimensions, maximum temperature, mean temperature, and temperature variance.

In some embodiments, detecting thermal signature growth comprises: calculating a first spatial extent area of a thermal signature in a first thermal image; calculating a second spatial extent area of the thermal signature in a second thermal image captured at a later time; determining that spatial growth has occurred when the second spatial extent area exceeds the first spatial extent area by more than a spatial growth percentage threshold; measuring a first maximum temperature of the thermal signature in the first thermal image; measuring a second maximum temperature of the thermal signature in the second thermal image; determining that thermal growth has occurred when a rate of temperature increase from the first maximum temperature to the second maximum temperature exceeds a temperature growth rate threshold; and classifying the thermal signature as growing when at least one of spatial growth or thermal growth has occurred.

In some embodiments, the computer-implemented system for thermal hazard detection in waste handling equipment further comprises: a user correlation module configured to: receive transaction records from the waste compaction system, said transaction records comprising timestamps, user identifiers, and payment information; correlate thermal hazard events with transaction records by matching thermal hazard event timestamps to transaction timestamps within a time matching window; identify users associated with transactions during which thermal hazards were detected; store correlations between users and thermal hazard events in a database; and generate accountability reports identifying users who deposited hazardous materials.

In some embodiments, the control interface module is further configured to: be responsive to detecting a critical thermal signature with growing characteristics: transmit an immediate lock command to the waste compaction system preventing door unlocking; display an out-of-service message on a human-machine interface of the waste compaction system indicating fire hazard condition; activate fire suppression systems if available at the waste compaction system; transmit emergency notifications to fire department or emergency services with equipment location and hazard description; and maintain the waste compaction system in a locked out-of-service state until manual reset by authorized personnel after confirming hazard mitigation.

In some embodiments, the thermal monitoring application further comprises: a classification engine implemented by one or more processors and memories and configured to perform machine-learning-based classification operations on thermal image data, the classification engine being further configured to: receive labeled training data comprising thermal images with manually annotated classifications distinguishing hazardous thermal signatures from non-hazardous thermal signatures; train, using the labeled training data, a convolutional neural network classifier that generates hazard classification outputs supplied to a control subsystem to initiate thermal hazard mitigation control actions for monitored equipment; apply the trained convolutional neural network classifier to newly acquired thermal image data from one or more thermal imaging sensors to generate predicted hazard classifications for detected thermal signatures; and generate hazard probability scores representing a likelihood that the detected thermal signatures correspond to fire hazards, the hazard probability scores being provided to the control subsystem to selectively trigger thermal hazard mitigation control actions.

In another aspect, provided herein is a computer-implemented method for predictive fill level management in waste compaction systems comprising: receiving, by a server computer via a network, operational data from a waste compaction system, said operational data comprising: transaction records indicating timestamps and quantities of waste deposits, fill level sensor measurements indicating current fill level of a compaction chamber, and compaction cycle records indicating timestamps of compaction cycles and resulting fill level reductions; analyzing, by the server computer, the operational data to calculate operational metrics comprising: average waste deposit rate as a function of time of day and day of week, average compaction ratio achieved by compaction cycles, and receiver box capacity remaining; extracting, by the server computer, usage patterns from the operational data comprising: identifying peak usage periods when transaction frequency exceeds a threshold, identifying usage trends over multi-day periods, and calculating average waste quantity per transaction; calculating, by the server computer, a predicted time to full capacity by: determining a current fill rate based on recent fill level sensor measurements and recent transaction records; adjusting the current fill rate based on predicted future usage patterns derived from the usage patterns; dividing the receiver box capacity remaining by the adjusted fill rate to calculate predicted time to full; generating, by the server computer, a service dispatch recommendation when the predicted time to full capacity is less than a dispatch lead time threshold, said service dispatch recommendation comprising: equipment location coordinates, current fill level percentage, predicted time to full capacity, estimated waste weight, and recommended service window; and transmitting, by the server computer, the service dispatch recommendation to a waste hauling service provider system; wherein the method enables proactive scheduling of waste hauling services before equipment reaches full capacity.

In some embodiments, adjusting the current fill rate based on predicted future usage patterns comprises: determining a current time and a current day of week; retrieving from the usage patterns an expected transaction rate for upcoming time periods based on historical transaction rates for corresponding times and days; comparing the expected transaction rate to an average transaction rate used in calculating the current fill rate; calculating an adjustment multiplier as a ratio of the expected transaction rate to the average transaction rate; and multiplying the current fill rate by the adjustment multiplier to generate the adjusted fill rate; wherein the adjusted fill rate accounts for temporal variations in usage patterns improving prediction accuracy.

In some embodiments, the computer-implemented method further comprises: receiving, by the server computer, weather forecast data for a geographic location of the waste compaction system; analyzing historical correlations between weather conditions and transaction rates at the geographic location; determining that predicted adverse weather conditions are associated with reduced transaction rates based on the historical correlations; applying a weather adjustment factor reducing the adjusted fill rate when adverse weather conditions are predicted; and recalculating the predicted time to full capacity using the weather-adjusted fill rate.

In some embodiments, the computer-implemented method further comprises: tracking, by the server computer, actual service visit timestamps when waste hauling service is performed; comparing actual fill levels at service visit timestamps to predicted fill levels calculated by the prediction algorithm; calculating prediction error as a difference between actual and predicted fill levels; adjusting prediction method executed by a processors parameters to minimize prediction error over multiple service visits data-driven optimization techniques to adjust model parameters and improve accuracy and models executed to process sensor data and generate fault indicators that are used by the system to generate control outputs that at least one of: (i) adjust hydraulic or electrical operating limits of the waste compaction system, (ii) schedule maintenance activities, or (iii) transition the system between operational states including normal, reduced-capacity, and out-of-service modes; and storing updated prediction method parameters for future predictions.

In some embodiments, the computer-implemented method further comprises: maintaining, by the server computer, a service history database recording past service visits with timestamps and locations; analyzing the service history database to identify recurring service patterns for specific equipment or geographic regions; calculating average time between service visits for each equipment unit; detecting deviations from average time between service visits indicating changed usage patterns; and generating alerts when detected deviations exceed a threshold, said alerts prompting investigation of usage pattern changes.

In some embodiments, calculating average compaction ratio comprises: identifying compaction cycle events from the compaction cycle records; for each compaction cycle event: determining a fill level immediately before the compaction cycle; determining a fill level immediately after the compaction cycle; calculating a fill level reduction as a difference between fill levels before and after compaction; calculating a compaction ratio for the cycle as a ratio of fill level before to fill level reduction; aggregating compaction ratios across multiple compaction cycles; calculating the average compaction ratio as a mean of aggregated compaction ratios; and using the average compaction ratio to predict how much capacity will be recovered by future compaction cycles.

This method provides advantages over prior art by: applying predictive algorithms specifically to waste compaction operations accounting for variable compaction ratios, usage patterns, and capacity metrics not disclosed in general waste tracking systems like the '920 publication; enabling optimized logistics for waste hauling services through accurate predictions; and integrating transaction-level data with physical fill measurements for improved prediction accuracy.

In another aspect, provided herein is a non-transitory computer-readable storage medium encoded with a computer program including instructions executable by a processor to create a fleet management system for waste compaction equipment comprising: a database storing equipment records for a plurality of deployed waste compaction systems, each equipment record comprising: equipment identifier, geographic location coordinates, equipment configuration data, sensor data streams, diagnostic status, and maintenance history; a map visualization module configured to: generate a map display showing geographic locations of the plurality of waste compaction systems; overlay status indicators on the map display indicating operational status of each waste compaction system using color-coding corresponding to status categories selected from: operational (green), service needed soon (yellow), urgent service required (red), and offline (gray); enable user interaction to select individual waste compaction systems on the map display and view detailed status information; a comparative analytics module configured to: aggregate operational metrics across the plurality of waste compaction systems; calculate fleet-wide statistics including: average uptime percentage, average revenue per system, average compaction cycles per day, and average time between failures; identify outlier systems exhibiting metrics deviating from fleet averages by more than a statistical threshold; generate performance ranking reports ranking waste compaction systems by selected metrics; a maintenance coordination module configured to: receive service dispatch recommendations from individual waste compaction systems; consolidate service dispatch recommendations by geographic proximity to enable efficient routing of service vehicles by generating routing control parameters subject to vehicle capacity, equipment availability, and service timing constraints; generate maintenance technician assignments specifying which technician should service which waste compaction systems based on technician location, availability, and skill qualifications; transmit maintenance work orders to technician mobile devices including equipment identifiers, locations, diagnostic information, and recommended actions; and an optimization recommendation module configured to: analyze geographic distribution of waste compaction systems and transaction volume data; identify underserved locations where waste compaction systems experience high demand exceeding capacity; identify candidate locations for additional waste compaction system deployments based on geographic gaps and demographic data; generate reports for operators regarding fleet performance, expansion opportunities, and optimization recommendations.

In some embodiments, the comparative analytics module is configured to: for each operational metric, calculate a fleet-wide mean value and a fleet-wide standard deviation; for each waste compaction system, calculate a z-score for each operational metric representing how many standard deviations the system's metric deviates from the fleet-wide mean; identify a system as an outlier for a specific metric when the absolute value of the z-score exceeds a threshold value; generate outlier reports listing outlier systems with metrics deviating significantly from fleet norms; for each outlier, generate diagnostic hypotheses explaining why the system is an outlier; and prioritize outliers for investigation based on magnitude of deviation and business impact.

In some embodiments, consolidating service dispatch recommendations by geographic proximity comprises: organizing service dispatch recommendations into a list with geographic location coordinates; applying a clustering method executed by a processor to group service dispatch recommendations having location coordinates within a proximity threshold into geographic clusters; for each geographic cluster: calculating a cluster centroid representing an average location of all service dispatch recommendations in the cluster; identifying available service technicians within a maximum travel distance of the cluster centroid; calculating total estimated service time for all service dispatch recommendations in the cluster; determining whether a single service visit can address all service dispatch recommendations in the cluster based on available technician time and vehicle capacity; if consolidation is feasible, generating a consolidated work order specifying all equipment to be serviced during a single multi-stop visit; and optimizing routing sequence for the multi-stop visit to minimize total travel distance.

In some embodiments, generating maintenance technician assignments comprises: maintaining a technician database storing for each technician: current location coordinates, schedule availability, skill certifications, assigned territory, and vehicle equipment capacity; for each service dispatch recommendation, determining required skills based on diagnostic information; filtering available technicians to identify technicians having required skills and schedule availability during the recommended service window; for each filtered available technician, calculating travel distance from current location to equipment location; selecting a technician that minimizes at least one criterion selected from the group consisting of: travel distance, response time, and total service cost; assigning the service dispatch recommendation to the selected technician by creating a work order record linked to the technician; and transmitting the work order to the technician's mobile device via push notification, SMS, or email.

In some embodiments, the optimization recommendation module is configured to: define a geographic grid dividing a service area into cells; for each grid cell, aggregate transaction volume from all waste compaction systems located within the cell; calculate transaction density as transactions per unit area or transactions per capita based on population data; identify high-demand cells where transaction density exceeds an upper threshold; identify low-demand cells where transaction density is below a lower threshold; recommend relocating waste compaction systems from low-demand cells to high-demand cells to optimize demand matching; identify cells without deployed waste compaction systems but adjacent to high-demand cells as candidate expansion locations; and generate deployment priority rankings for candidate locations based on predicted demand and proximity to existing infrastructure.

In some embodiments, the fleet management system further comprises: a financial analytics module configured to: aggregate revenue data from transaction records across all waste compaction systems; aggregate cost data including: equipment capital costs, maintenance and repair costs, waste hauling costs, communication costs, and software licensing costs; calculate per-unit financial metrics for each waste compaction system comprising: total revenue, total costs, gross profit, profit margin, and return on investment; generate profitability reports ranking waste compaction systems by profitability; identify unprofitable systems where costs exceed revenue; generate recommendations for unprofitable systems selected from: increasing pricing, reducing service frequency, relocating to higher-demand locations, or decommissioning.

In some embodiments, the financial analytics module is configured to: generate, track and record transactions for every end-user use, wherein the module will generate a QR code accessible by the end-user at the kiosk to gain access to a customer transaction receipt from the Cloud for each completed transaction; and further track each completed transaction, store, and report all transactions to Cloud Services for later analysis for per-unit financial metrics for each waste compaction system.

This aspect provides advantages over prior art by providing fleet management capabilities specifically designed for distributed autonomous waste compaction systems not disclosed in any prior art; enabling data-driven deployment and operational decisions; integrating real-time diagnostics with logistics optimization; and providing comprehensive business intelligence not available with prior art waste management systems.

In another aspect, provided herein is a computer-implemented system for comprehensive waste compaction equipment monitoring comprising: a cloud-based monitoring platform comprising: a data ingestion service configured to receive sensor data from a plurality of distributed waste compaction systems via network connections; a time-series database configured to store sensor data with timestamps enabling efficient time-series queries; a diagnostic processing service configured to execute diagnostic algorithms that process sensor data to generate fault signals used to trigger maintenance alerts or operational control actions; a predictive analytics service configured to calculate remaining useful life estimates for equipment components based on degradation trends; a thermal analysis service configured to process thermal image data to detect fire hazards; a notification service configured to generate and transmit alert notifications via multiple communication channels; an API service exposing application programming interfaces enabling client applications to query data and control equipment remotely; and a web application providing user interfaces for fleet monitoring, equipment diagnostics, and remote control.

In some embodiments, the diagnostic processing service implements a plurality of specialized diagnostic modules comprising: a hydraulic diagnostic module analyzing hydraulic pressure patterns to detect hydraulic system faults; an electrical diagnostic module analyzing electrical current signatures to detect electrical system faults; a mechanical diagnostic module analyzing vibration data to detect bearing wear and mechanical issues; a sensor health diagnostic module verifying sensor functionality and detecting sensor failures; and a communication diagnostic module monitoring network connectivity and data transmission reliability; wherein each specialized diagnostic module operates independently and generates diagnostic reports specific to its subsystem.

In some embodiments, computer-implemented system for comprehensive waste compaction equipment monitoring further comprises a data-driven optimization pipeline configured to: extract features from historical sensor data including statistical metrics, frequency domain features, and time-domain features; deploy trained models to generate fault prediction outputs, wherein the fault prediction outputs are automatically consumed by the system to generate maintenance work orders, disable operation of affected equipment, or adjust operating parameters of the waste compaction system.

In some embodiments, the cloud-based monitoring platform further comprises: a data retention policy manager configured to: store high-resolution sensor data for a short-term retention period; down-sample high-resolution sensor data to lower resolution summary statistics after the short-term retention period; store down-sampled data for a medium-term retention period; archive down-sampled data to long-term cold storage after the medium-term retention period; and automatically delete archived data after exceeding a maximum retention period; wherein the data retention policy manager balances data availability for analysis with storage costs.

Additional aspects and advantages of the present disclosure will become readily apparent to those skilled in this art from the following detailed description, wherein only exemplary embodiments of the present disclosure are shown and described, simply by way of illustration of the several modes or best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the system are set forth with particularity in the appended claims. A better understanding of the features and advantages of the present system will be obtained by reference to the following detailed description that sets forth illustrative embodiments, in which the principles of the system are utilized, and the accompanying drawings of which:

FIG. 1-A is a perspective view of an interactive, automated-access commercial trash compactor system showing the integrated control cabinet, payment kiosk, and compactor housing;

FIG. 1-B is a simplified schematic cross-sectional view of a commercial trash compactor compaction chamber showing the ram/platen, receiving chamber, and discharge door;

FIG. 2 is a front perspective view of a point-of-pay (POP) digital payment system kiosk showing the sized receiving bin, automated access door, display screen, keyboard panel, activation buttons, and payment collection devices;

FIG. 3 is a side perspective view of the POP digital payment system kiosk showing the open receiving bin in greater detail;

FIG. 4 is a detailed view of the payment kiosk interface components including the digital screen display, keyboard/display panel, activation and deactivation buttons, and payment collection device with NFC/contactless readers;

FIG. 5 is a front elevation view of the POP digital payment system kiosk showing dimensional relationships and component placement;

FIG. 6 is a detailed flow diagram of the cabinet control subsystems showing PLCs, HMI, sensors, actuators, contactors, relays, and operator override functions;

FIG. 7 is a detailed operational view flow diagram of the cloud services interface showing API services, data logging, notifications, analytics dashboards, payment processing services, video feed transmission, etc.;

FIG. 8 is a detailed system composition view flow diagram of the entire system and subsystems showing the control cabinet, control systems, controller, communications, sensors, position GPS, Power systems, and optional equipment including generators, batteries and solar panels;

FIG. 9 is a detailed operational view flow diagram of the Customer Use Case Overview of the entire system;

FIG. 10 is a detailed operational view flow diagram of the normal Operations of the Machine Internal Systems Flow;

FIG. 11 is a system architecture diagram showing cloud-integrated monitoring and diagnostic system components including local sensors, communication pathways, cloud services, and operator interfaces;

FIG. 12 is a detailed block diagram of cloud services architecture showing data logging, analytics processing, notification services, payment processing integration, and API interfaces;

FIG. 13 is a flow diagram illustrating cabinet control subsystems showing sensor interfaces, data acquisition, local processing, and cloud communication;

FIG. 14 is a state-based flow diagram showing diagnostic routine execution sequences including sensor polling, actuator testing, communication verification, and report generation;

FIG. 15 is a software flow diagram illustrating maintenance operations workflow showing diagnostic data access, manual control capabilities, and system configuration interfaces;

FIG. 16 is a software flow diagram illustrating administrator operations via cloud application showing fleet monitoring dashboards, analytics interfaces, remote control capabilities, and configuration management;

FIG. 17 is a software flow diagram showing transaction processing integrated with real-time diagnostics and cloud data synchronization;

FIG. 18 is a flowchart illustrating a hydraulic system diagnostic method executed by a processor showing pressure data acquisition, statistical analysis, anomaly detection, and fault classification;

FIG. 19 is a flowchart illustrating predictive maintenance method executed by a processor showing degradation trend analysis, remaining useful life of one or more components and generate a maintenance timing signal used to schedule servicing or limit operation of the component;

FIG. 20 is a flowchart illustrating a thermal hazard detection method executed by a processor showing thermal image acquisition, signature identification, temporal analysis, and alert generation;

FIG. 21 is a flowchart illustrating fill level prediction method executed by a processor showing usage pattern extraction, rate calculation, time-to-full prediction, and service dispatch recommendation generation;

FIG. 22 is a block diagram of cloud-based analytics processing architecture showing data ingestion pipelines, processing engines, storage systems, and API layers;

FIG. 23 is a screenshot mockup of fleet management dashboard showing map visualization with status indicators, summary statistics, and alert notifications;

FIG. 24 is a screenshot mockup of equipment detail view showing real-time sensor data, diagnostic status, maintenance history, and control interfaces;

FIG. 25 is a graph showing example hydraulic pressure data over multiple compaction cycles with annotated baseline, degradation trend, and predicted failure point;

FIG. 26 is a graph showing example fill level prediction with historical actual fill levels, predicted trajectory, and service dispatch recommendation point.

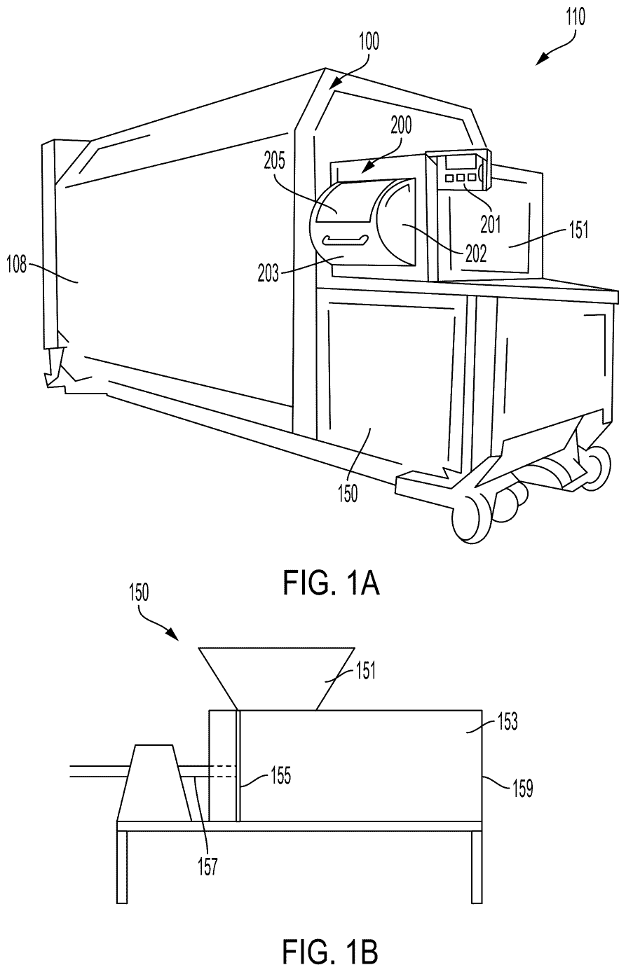

FIGS. 1A-1B illustrate example installations including stationary compactors with detachable receiver boxes and mobile compactor platforms.

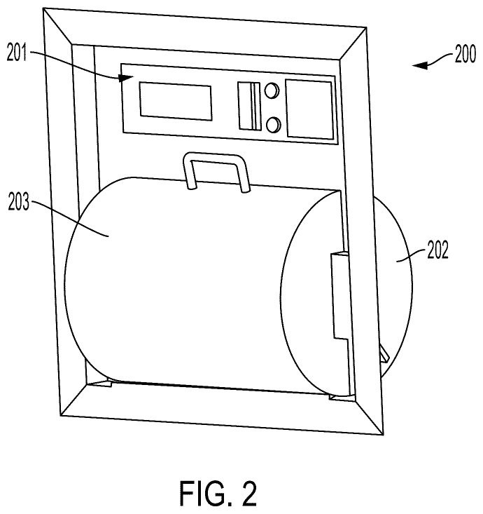

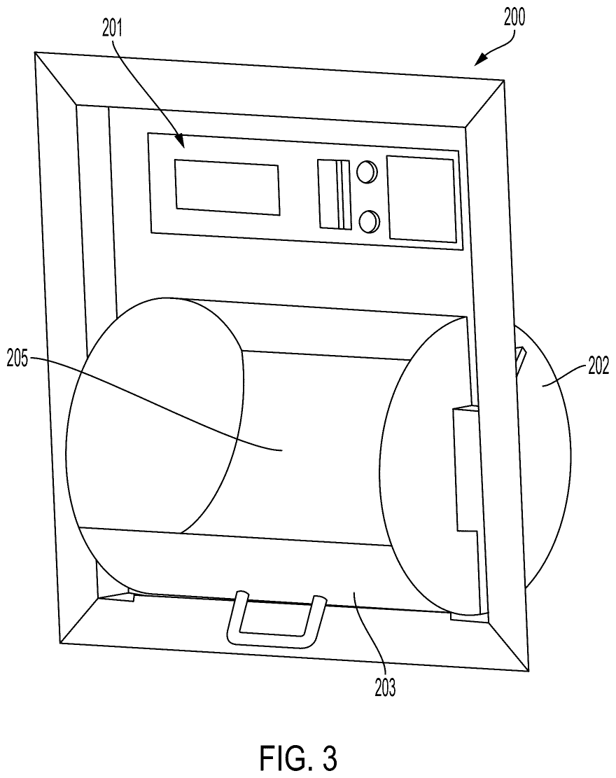

FIGS. 2-5 illustrate an example POP/POS kiosk with a receiving bin and an access door.

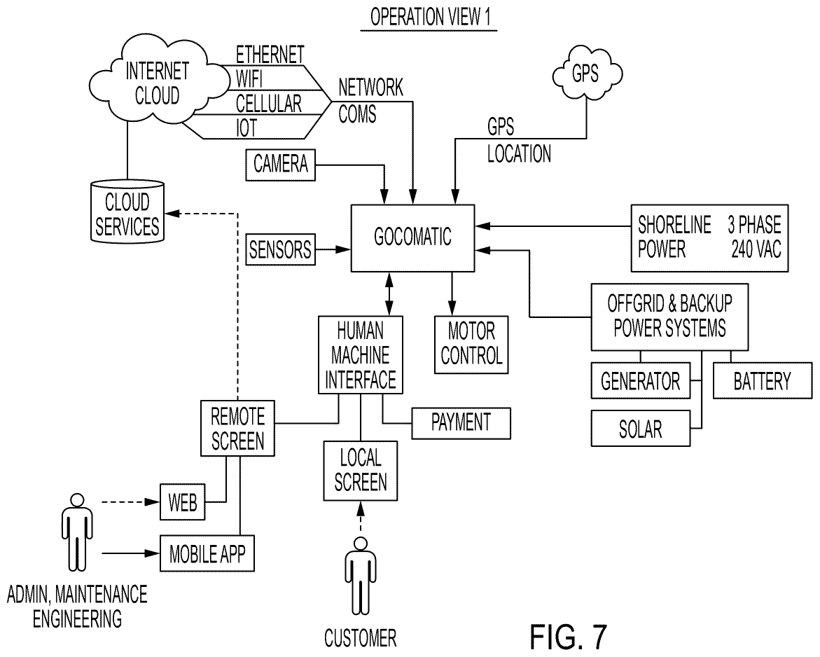

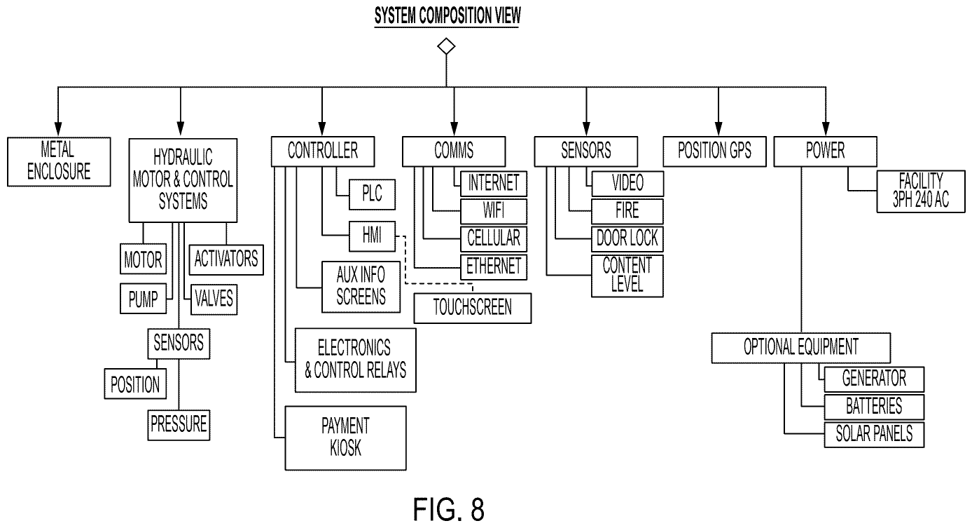

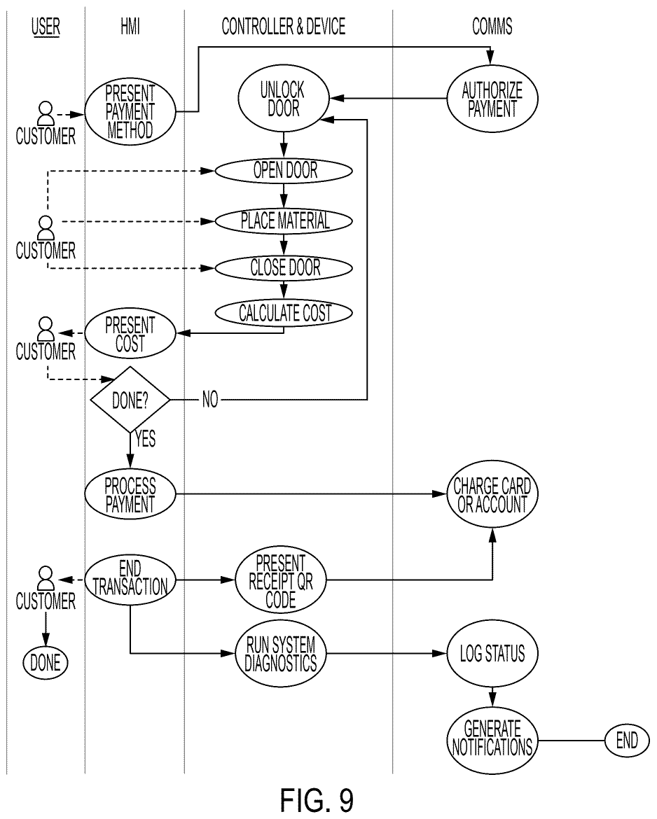

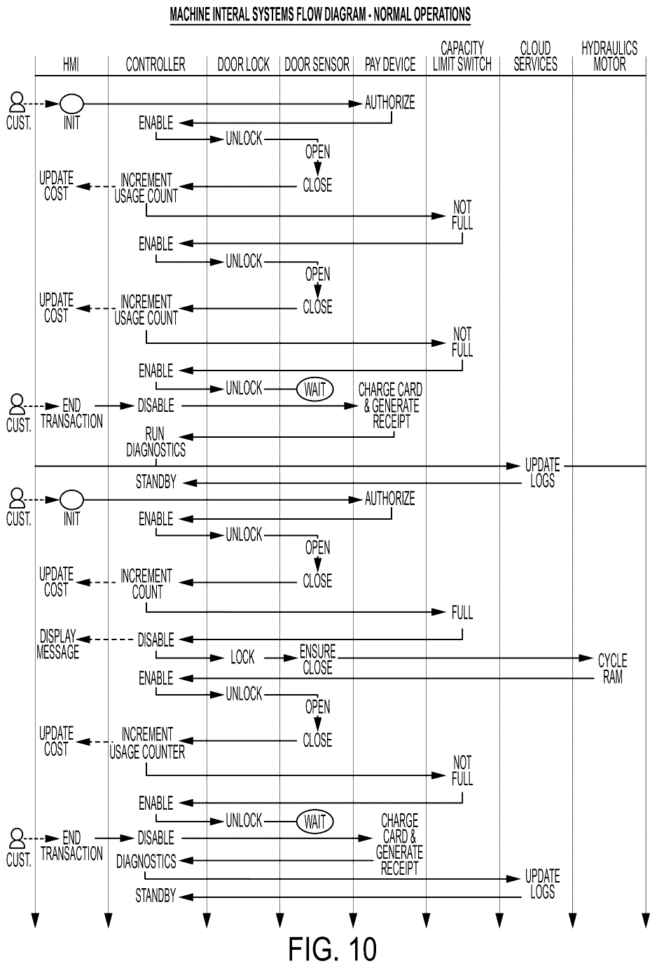

FIGS. 7-10

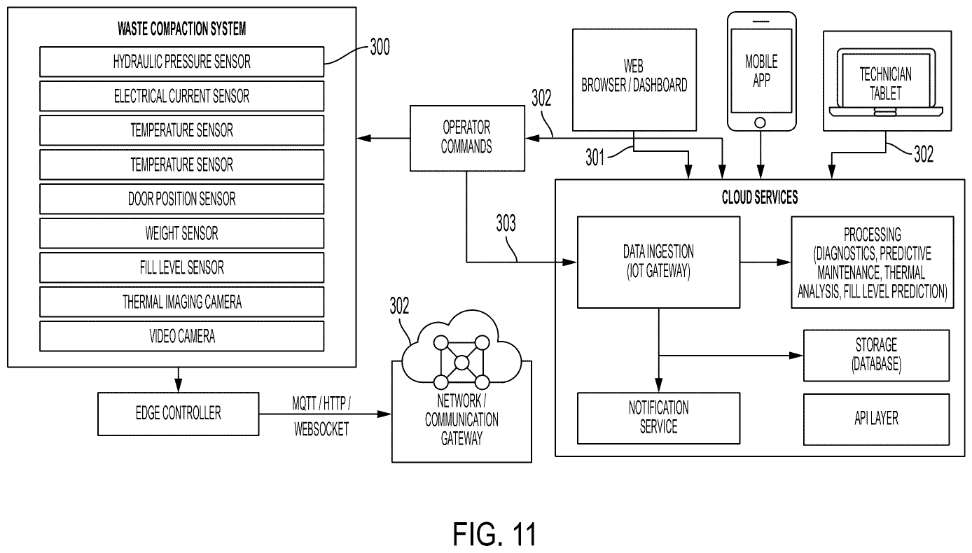

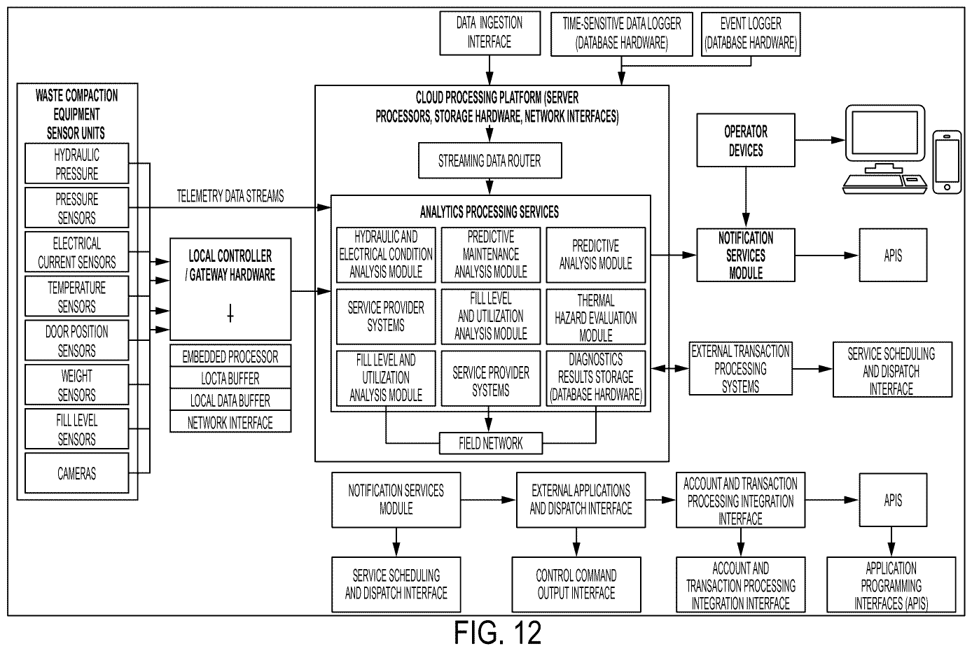

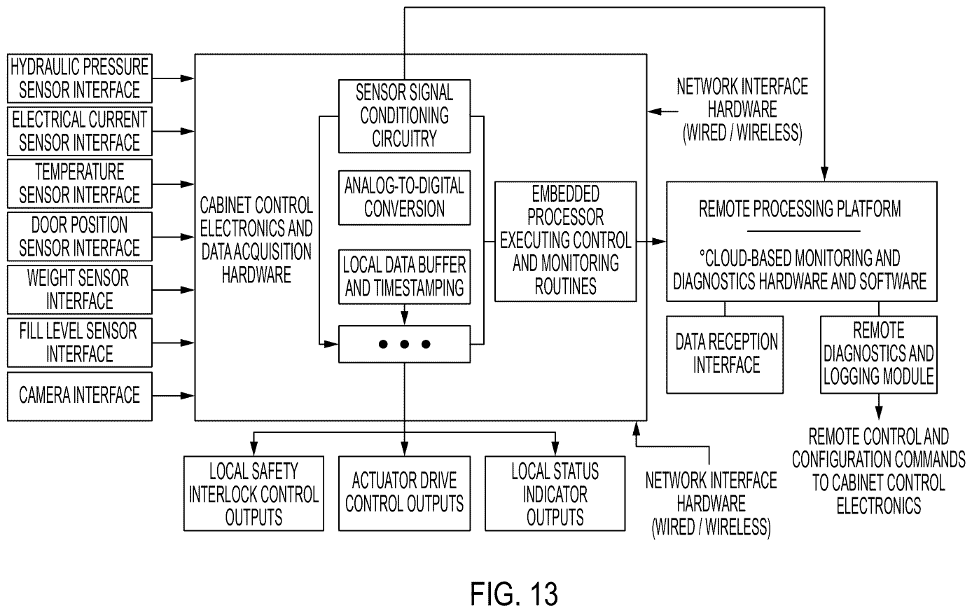

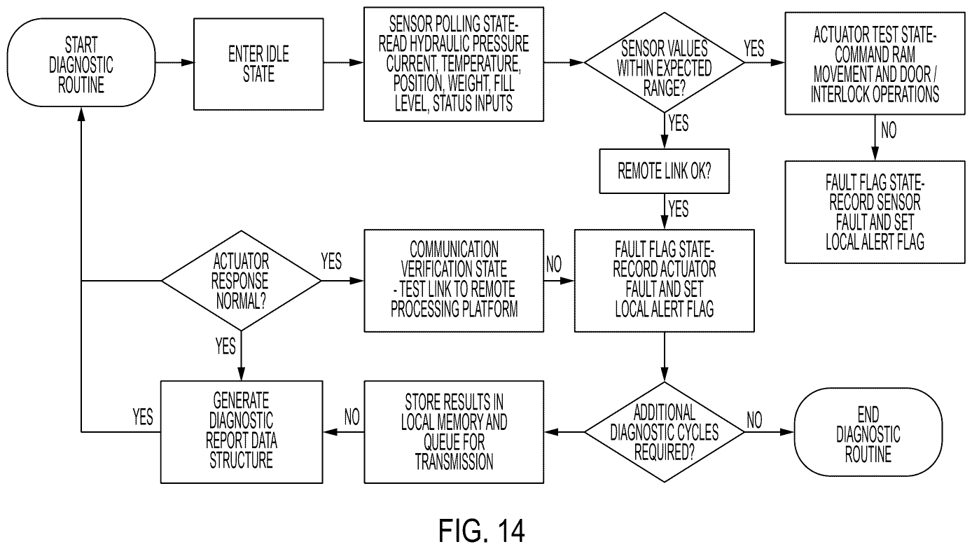

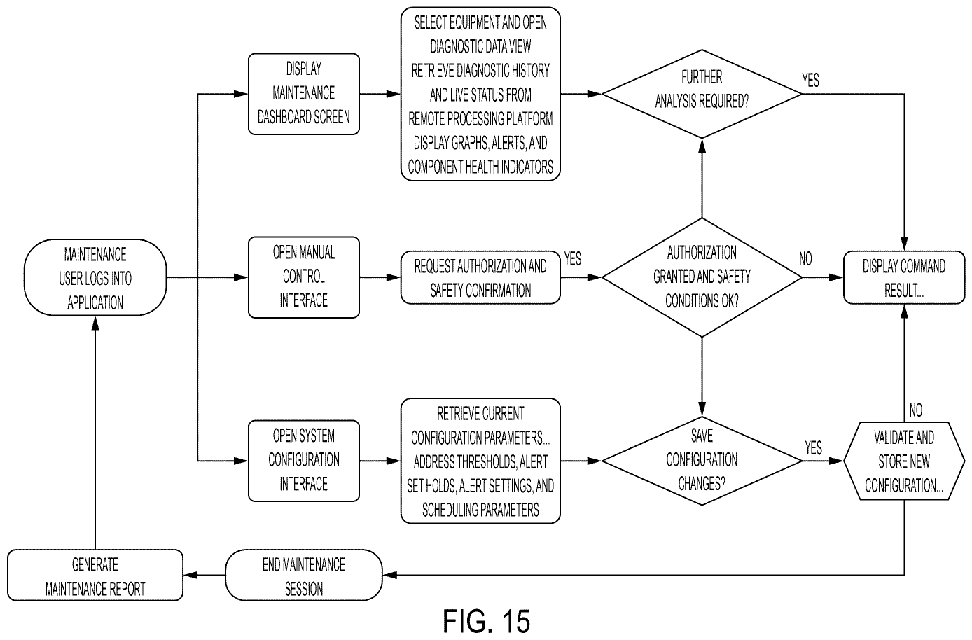

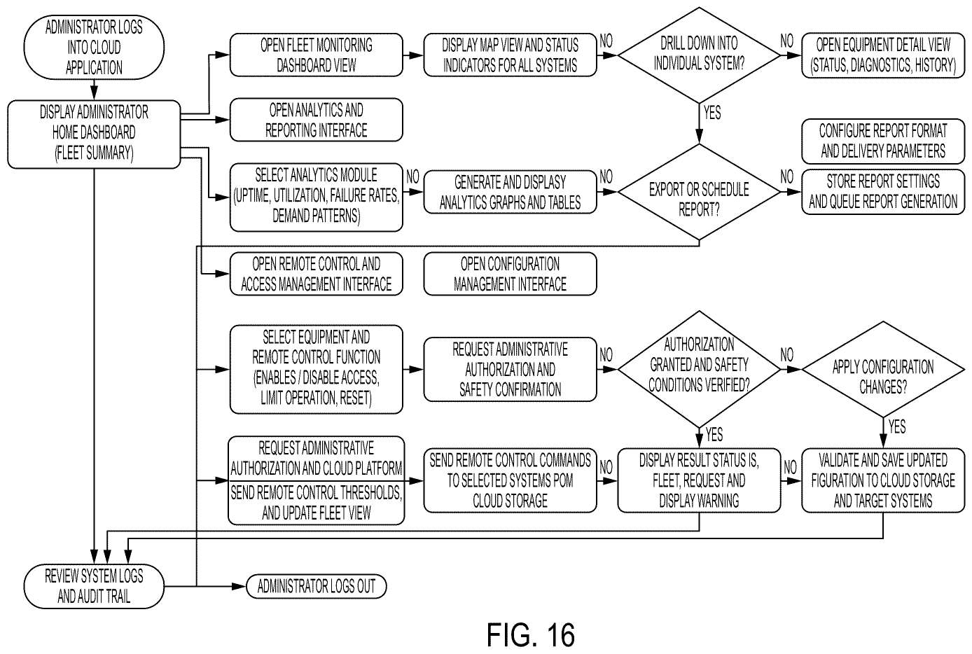

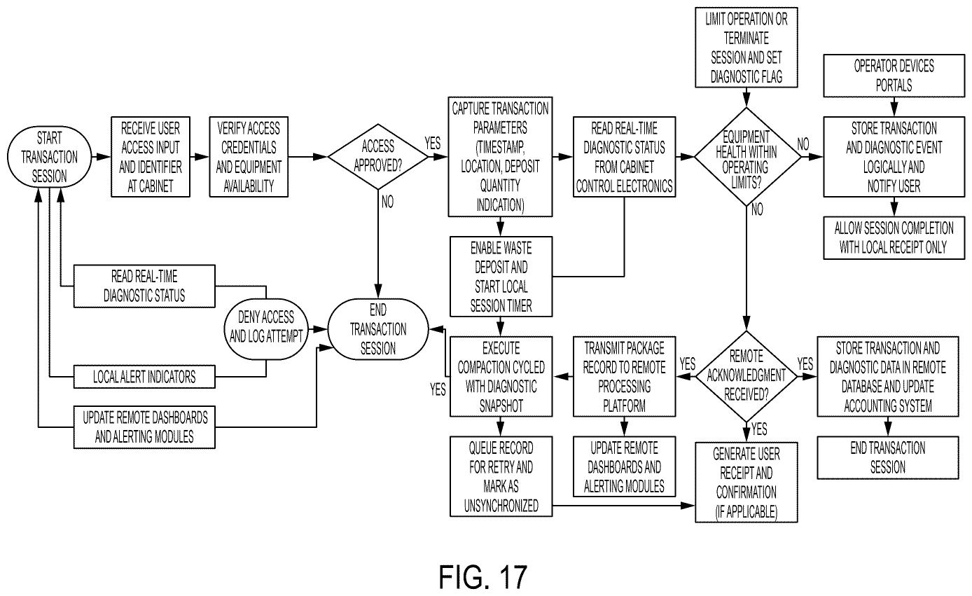

FIGS. 11-26 illustrate an example system architecture diagram showing cloud-integrated monitoring and diagnostic system components, cloud services architecture, cabinet control subsystems, diagnostic routine execution sequences, software flow diagram illustrating maintenance operations workflow, administrator operations via cloud application, transaction processing integrated with real-time diagnostics, hydraulic system diagnostic method executed by a processor, predictive maintenance method, thermal hazard detection method, fill level prediction method executed by a processor, cloud-based analytics processing architecture, a mockup of a fleet management dashboard, a mockup of equipment detail view, example hydraulic pressure data over multiple compaction cycles and example fill level prediction with historical actual fill levels, predicted trajectory, and service dispatch recommendation point.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

While preferred embodiments of the present system have been shown and described herein, it will be obvious to those skilled in the art that such embodiments are provided by way of example only. Numerous variations, changes, and substitutions will now occur to those skilled in the art without departing from the system. It should be understood that various alternatives to the embodiments of the system described herein may be employed in practicing the system.

The present device will now be described more fully hereinafter with reference to the accompanying drawings which illustrate embodiments of the WASTE MANAGEMENT EQUIPMENT MONITORING, DIAGNOSTIC, AND PREDICTIVE MAINTENANCE SYSTEM. This system may, however, be embodied in many different forms and should not be construed as limited to the illustrated embodiments set forth herein. Rather, these embodiments are provided so that this disclosure will be thorough and complete, and will fully convey the scope of the device to those skilled in the art.

The following description of the exemplary embodiments refers to the accompanying drawings. The following detailed description does not limit the system. Instead, the scope of the system is defined by the appended claims.

Reference throughout the disclosure to “an exemplary embodiment,” “an embodiment,” or variations thereof means that a particular feature, structure, or characteristic described in connection with an embodiment is included in at least one embodiment of the subject matter disclosed. Thus, the appearance of the phrases “in an exemplary embodiment,” “in an embodiment,” or variations thereof in various places throughout the disclosure is not necessarily referring to the same embodiment. Further, the particular features, structures or characteristics may be combined in any suitable manner in one or more embodiments.

As used herein, and unless otherwise specified, the term “autonomous operation” refers to operation of the waste compaction system without requiring on-site human operators, where all essential functions including payment authorization, access control, waste acceptance, compaction actuation, capacity monitoring, and diagnostic reporting are performed automatically by integrated control systems.

As used herein, and unless otherwise specified, the term “cycle” refers to a single opening and closing sequence of the automated access door, permitting a user to deposit waste material into the receiving bin once per cycle.

As used herein, “authorized cycle count” is a stored value defining a maximum number of cycles permitted during a transaction session before re-locking, unless early completion occurs.

As used herein, “POP/POS” refers to a point-of-payment/point-of-sale interface that accepts user payment credentials or account credentials and produces an authorization result. As used herein, a “transaction session” begins when an authorization signal is received for a user and ends when the door is re-locked after completion criteria are met.

As used herein, and unless otherwise specified, the term “state-based control logic” or “state machine control” refers to a control algorithm wherein the system operates in distinct operational states (such as standby, authorized access, door open, evaluating capacity, compacting, etc.) and transitions between states based on specific events or conditions detected by sensors or timers.

As used herein, and unless otherwise specified, the term “cloud services” refers to remote server infrastructure accessible via wide area networks (such as the Internet) providing data storage, analytics processing, user interfaces via web applications or mobile applications, and API services for system integration.

As used herein, and unless otherwise specified, the term “PLC” refers to a programmable logic controller, which is a ruggedized industrial computer designed for control of manufacturing processes, machinery, or electromechanical systems through digital or analog inputs and outputs.

As used herein, and unless otherwise specified, the term “predictive maintenance” refers to maintenance strategies that determine maintenance timing by processing sensor data to generate operational maintenance indicators used to initiate servicing actions prior to equipment failure.

As used herein, and unless otherwise specified, the term “thermal signature” refers to a localized region within a thermal image exhibiting elevated temperature relative to surrounding regions, indicative of heat-generating materials, exothermic reactions, or combustion processes.

As used herein, and unless otherwise specified, the term “degradation trend” refers to a time-series pattern in sensor measurements or operational metrics indicating progressive deterioration of equipment performance or component condition.

As used herein, and unless otherwise specified, the term “remaining useful life (RUL)” refers to an estimated time duration until a component or system is predicted to fail or require service, calculated based on current condition, degradation rate, and failure thresholds.

As used herein, and unless otherwise specified, the term “fleet” refers to a collection of multiple waste compaction systems deployed at different geographic locations and monitored or managed collectively through a unified system.

As used herein, and unless otherwise specified, the term “outlier” refers to a data point, measurement, or equipment unit exhibiting characteristics that deviate significantly from expected values, averages, or norms, typically defined as exceeding a statistical threshold such as two or three standard deviations from the mean.

As used herein, the terms “comprises”, “comprising”, or any other variation thereof, are intended to cover a nonexclusive inclusion, such that a process, method, article, or apparatus that comprises a list of elements does not include only those elements but may include other elements not expressly listed or inherent to such process, method, article, or apparatus.

As used herein, and unless otherwise specified, the term “about” or “approximately” means the system or device further comprises an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. In certain embodiments, the term “about” or “approximately” means within 40.0 mm, 30.0 mm, 20.0 mm, 10.0 mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “about” or “approximately” means within 5.0 kg, 2.5 kg, 1.0 kg, 0.9 kg, 0.8 kg, 0.7 kg, 0.6 kg, 0.5 kg, 0.4 kg, 0.3 kg, 0.2 kg or 0.1 kg of a given value or range, including increments therein. In certain embodiments, the term “about” or “approximately” means within 1 hour, within 45 minutes, within 30 minutes, within 25 minutes, within 20 minutes, within 15 minutes, within 10 minutes, within 5 minutes, within 4 minutes, within 3 minutes, within 2 minutes, or within 1 minute. In certain embodiments, the term “about” or “approximately” means within 20.0 degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.09 degrees. 0.08 degrees, 0.07 degrees, 0.06 degrees, 0.05 degrees, 0.04 degrees, 0.03 degrees, 0.02 degrees or 0.01 degrees of a given value or range, including increments therein.

As used herein, and unless otherwise specified, the term “substantially”, or “substantially equal” means within 1 or 2 standard deviations. In certain embodiments, the term “substantially”, or “substantially equal” means within 5%, 4%, 3%, 2%, 1%, 0.5%, 0.1%, or 0.05% of a given value or range. In certain embodiments, the term “substantially”, or “substantially equal” means within 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “substantially”, or “substantially equal” means within 1.0 kg, 0.9 kg, 0.8 kg, 0.7 kg, 0.6 kg, 0.5 kg, 0.4 kg, 0.3 kg, 0.2 kg or 0.1 kg of a given value or range, including increments therein. In certain embodiments, the term “substantially”, or “substantially equal” means within 2 minutes, or within 1 minute. In certain embodiments, the term “substantially”, or “substantially equal” means within 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.09 degrees. 0.08 degrees, 0.07 degrees, 0.06 degrees, 0.05 degrees, 0.04 degrees, 0.03 degrees, 0.02 degrees or 0.01 degrees of a given value or range, including increments therein.

As used herein, and unless otherwise specified, the term “plurality”, and like terms, refers to a number (of things) comprising at least one (thing), or greater than one (thing), as in “two or more” (things), “three or more” (things), “four or more” (things), etc.

As used herein, the terms “connected”, “operationally connected”, “coupled”, “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein, the term “proximity” means nearness in space or relationship but not excluding the potential to be touching. Proximity is also alternatively meant to mean that one thing may be so close to another thing as to be “in direct or nearly direct contact” (in proximity) with another thing along some point. To “place something in proximity” is also meant to mean that items are “paired” or “mated together” either in their paired function or at some point of contact.

As used herein, and unless otherwise specified, the term “vertically oriented” and similar terms mean; generally perpendicular to, at, or near, right angles to a horizontal plane; in a direction or having an alignment such that the top of a thing is above the bottom. In certain embodiments, the term “vertically oriented” means within ±20.0 degrees, ±15.0 degrees, ±10.0 degrees, ±9.0 degrees, ±8.0 degrees, ±7.0 degrees, ±6.0 degrees, ±5.0 degrees, ±4.0 degrees, ±3.0 degrees, ±2.0 degrees, ±1.0 degrees, ±0.9 degrees, ±0.8 degrees, ±0.7 degrees, ±0.6 degrees, ±0.5 degrees, ±0.4 degrees, ±0.3 degrees, ±0.2 degrees or ±0.1 degrees of a given value or range, including increments therein.

As used herein, and unless otherwise specified, the term “horizontally oriented” and similar terms mean; generally perpendicular to, at, or near, right angles to a vertical plane; in a direction or having an alignment such that the top of a thing is generally on, or near the same plane as the bottom, both being parallel or near parallel to the horizon. In certain embodiments, the term “horizontally oriented” means within ±20.0 degrees, ±15.0 degrees, ±10.0 degrees, ±9.0 degrees, ±8.0 degrees, ±7.0 degrees, ±6.0 degrees, ±5.0 degrees, ±4.0 degrees, ±3.0 degrees, ±2.0 degrees, ±1.0 degrees, ±0.9 degrees, ±0.8 degrees, ±0.7 degrees, ±0.6 degrees, ±0.5 degrees, ±0.4 degrees, ±0.3 degrees, ±0.2 degrees or ±0.1 degrees of a given value or range, including increments therein.

As used herein, and unless otherwise specified, the term “substantially perpendicular” and similar terms mean generally at or near 90 degrees to a given line, or surface or to the ground. In certain embodiments, the term “substantially perpendicular” means within ±20.0 degrees, ±15.0 degrees, ±10.0 degrees, ±9.0 degrees, ±8.0 degrees, ±7.0 degrees, ±6.0 degrees, ±5.0 degrees, ±4.0 degrees, ±3.0 degrees, ±2.0 degrees, ±1.0 degrees, ±0.9 degrees, ±0.8 degrees, ±0.7 degrees, ±0.6 degrees, ±0.5 degrees, ±0.4 degrees, ±0.3 degrees, ±0.2 degrees or ±0.1 degrees of a given value or range, including increments therein.

As used herein, and unless otherwise specified, combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

### Description of Related Art

Commercial waste compaction equipment operates in demanding environments with frequent mechanical cycling, exposure to diverse waste materials, and limited access for routine inspection. Equipment failures result in operational downtime, service call costs, and lost revenue. Traditional maintenance approaches rely on fixed schedules (time-based maintenance) or reactive repairs after equipment failure (run-to-failure maintenance), both of which are inefficient and costly.

Some prior art systems provide basic monitoring of waste equipment. US 2015/0196920 A1 (hereinafter “the '920 publication”) discloses a network-connected weight tracking system for food waste disposal machines that uploads weight data to cloud servers for tracking waste quantities. However, the '920 publication is directed solely to waste quantity tracking for billing purposes and provides no disclosure of: (i) equipment health monitoring through analysis of operational parameters; (ii) diagnostic algorithms for detecting equipment faults; (iii) predictive maintenance based on sensor data patterns; (iv) hazardous material detection through thermal imaging analysis; (v) hydraulic system monitoring for compactor equipment; or (vi) automated alert generation based on equipment health metrics.

Other prior art systems provide cloud-based monitoring for various types of industrial equipment. U.S. Pat. No. 9,967,168 B2 (hereinafter “the '168 patent”) discloses a remote real-time monitoring system based on cloud computing for industrial equipment that collects sensor data and displays it via web interfaces. However, the '168 patent provides only generic disclosure of data collection and display without specific application to waste compaction equipment, and fails to disclose: (i) diagnostic algorithms specific to hydraulic compaction systems; (ii) predictive maintenance algorithms analyzing compaction cycle patterns; (iii) thermal imaging for safety monitoring in waste handling applications; (iv) fill level prediction algorithms for scheduling waste hauling services; or (v) integration with payment and access control systems for comprehensive operational analytics.

Prior art fire detection systems exist for waste management facilities. U.S. Pat. No. 5,592,151 (hereinafter “the '151 patent”) discloses fire monitoring systems for large-scale waste facilities using distributed sensors and video cameras. However, the '151 patent is directed to facility-wide fire detection infrastructure and provides no disclosure of: (i) thermal imaging integrated into individual waste compaction units for detecting hazardous materials deposited by users; (ii) real-time thermal signature analysis for preventing fire hazards before ignition occurs; (iii) correlation of thermal events with user identification and transaction data for security and accountability; or (iv) integration with access control systems to prevent continued operation upon detecting thermal hazards.

Prior art waste disposal monitoring systems have been proposed. U.S. Pat. No. 4,549,570 (hereinafter “the '570 patent”) discloses a waste disposal monitoring system using sensors and processors to track waste disposal events. However, the '570 patent is directed to tracking what waste is disposed and by whom, and provides no disclosure of equipment health monitoring, diagnostic algorithms, or predictive maintenance capabilities. cl System Overview

FIGS. 1A and 1B illustrate an example autonomous waste handling system 100 that may include: (i) a waste receiving bin assembly (e.g., at a POP/POS kiosk), (ii) a controller executing access control logic, and (iii) optional coupling to a commercial waste compactor and cloud services. In embodiments, the system is configured to allow unattended use by authorizing and tracking multiple door access cycles per paid transaction session, which can improve usability for users depositing multiple items while enabling predictable monetization per session. cl Mechanical Subsystem (Receiving Bin & Access Door)

FIGS. 2-5 illustrate an example POP/POS kiosk 201 that houses a receiving bin 202 and an access door 203 that a user opens to deposit waste. In embodiments, the receiving bin is sized by volume, weight, geometry, or combinations thereof to limit per-cycle deposits and improve safety and predictability of operation.

In some embodiments, the access door 203 is secured by a lock mechanism actuated by a lock actuator, such as a solenoid lock, motorized lock, or other electrically controllable locking assembly. In embodiments, the system includes at least one door position sensor configured to indicate at least a door-open condition and a door-closed condition.

### Control Cabinet and Controller

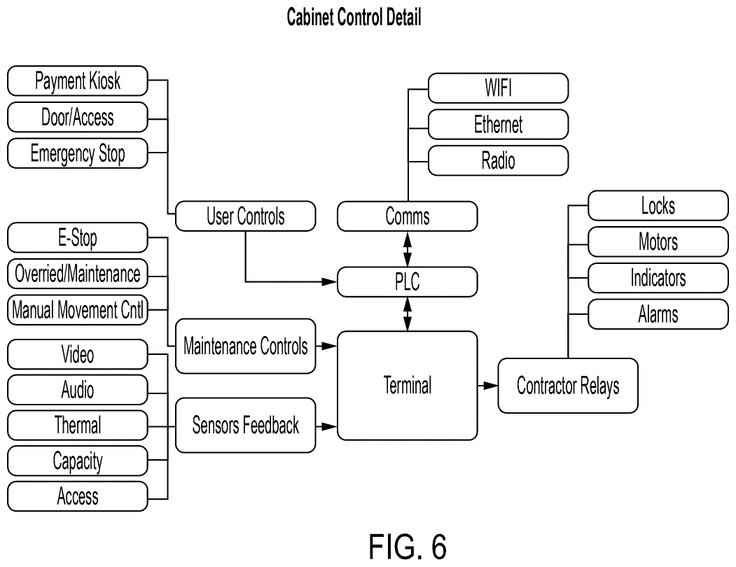

FIG. 6 illustrates an example control enclosure or control cabinet that may contain a controller (e.g., PLC), wiring, protection devices, and interfaces to sensors and actuators. In embodiments, the controller coordinates POP/POS authorization, door locking/unlocking, cycle counting, optional capacity monitoring, optional compaction actuation, and reporting/diagnostics.

In some embodiments, the cabinet includes a local user interface (e.g., an HMI) for user prompts, status messaging, and authorized maintenance access. In embodiments, the cabinet includes operator controls such as an emergency stop, a keyed maintenance enable, or other override controls for safe service operations.

FIGS. 7-10 illustrate detail operational view flow diagrams of the of the cloud services interface, of the entire system and subsystems, the Customer Use Case Overview and of the normal Operations of the Machine Internal Systems Flow.

FIGS. 11-26 illustrate flow diagrams of system architecture, cloud services architecture, cabinet control subsystems, state-based flow diagram showing diagnostic routine execution sequences, maintenance operations workflow, administrator operations via cloud application showing fleet monitoring dashboards, analytics interfaces, remote control capabilities, and configuration management, a software flow diagram, a flowchart illustrating a hydraulic system diagnostic method executed by a processor, predictive maintenance method, a thermal hazard detection method executed by a processor, fill level prediction method executed by a processor, a block diagram of cloud-based analytics processing architecture, a mockup of fleet management dashboard, mockup of equipment detail, a graph showing example hydraulic pressure data over multiple compaction cycles, and a graph showing example fill level predictions.

### Cloud-Integrated Autonomous Commercial Waste Compaction System With POP/POS Multi-Cycle Access Control System Overview

FIGS. 1A and 1B illustrate the overall system architecture of the cloud-integrated autonomous waste compaction system 100. The system comprises a commercial trash compactor 100, an interactive, automated commercial trash compactor system 110 integrated with the commercial compactor, and a cloud services infrastructure accessible via wide area network communications.

The commercial trash compactor 100 may be configured in various embodiments including: (i) a stationary compactor 120 with an affixed receiver box 108 as shown in FIG. 1-A.

Alternative embodiments (not shown, but described herein) may include the commercial trash compactor 100 configured in various embodiments including: (i) a stationary compactor with a detachable, transportable receiver box 108; (ii) a self-contained, mobile compactor system; (iii) a mobile, self-contained compactor; (iv) a self-contained mobile compactor trailer; or (v) a typical compactor garbage truck. All of the described alternative embodiments are known in the commercial trash collection and compactor industry; however none are known to include the point-of-pay (POP) or point-of-sale (POS) digital payment system 200 integrated with the commercial waste compactor, as described herein.

Each described embodiment/configuration includes a compactor platen/ram subsystem 150 comprising a waste hopper/chute 151, a receiving chamber/compaction chamber or charge box 153, a compaction plate/platen or ram 155, a power screw or hydraulic piston 157 for actuating the ram, and a discharge door 159 for the compaction chamber, as illustrated in FIG. 1-B. The compactor system receiver box 108 is positioned to receive compacted waste from the discharge door 159.

### Mechanical Subsystem (Point-of-Pay Digital Payment System)

FIGS. 2-5 illustrate the point-of-pay (POP) or point-of-sale (POS) digital payment system 200 integrated with each of the commercial waste compactors. The POP/POS digital payment system kiosk 201 houses the payment electronics, control systems, and user interface components. Unlike prior art systems such as the '743 publication which merely provide a locked container that unlocks upon payment, the present system integrates sophisticated cycle-based access control, real-time weight monitoring, and automated compaction triggering.

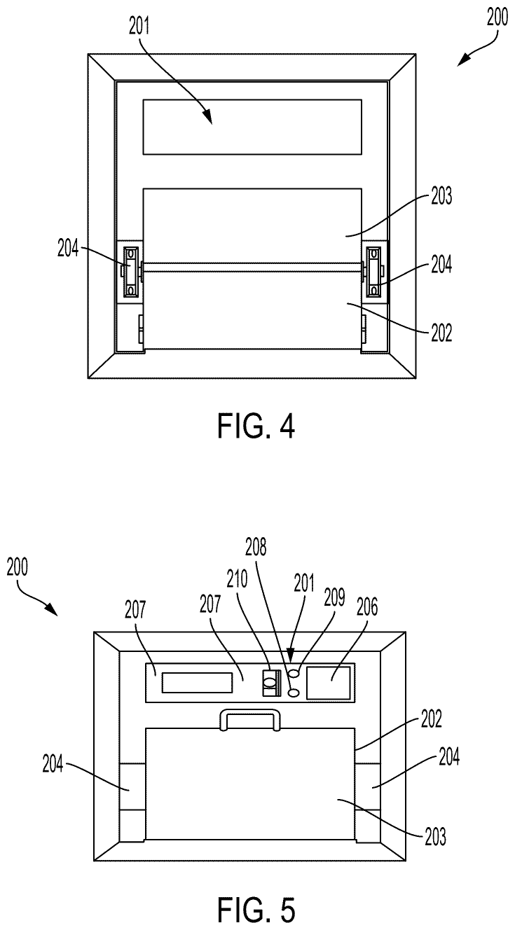

The sized receiving bin 202 is configured with specific volumetric capacity (for example, 0.25 cubic yards, 0.5 cubic yards, or 1.0 cubic yard) to limit the amount of waste accepted per cycle. The automated access door 203 is mounted on the receiving bin via special roller bearings 204 (as shown in FIGS. 4-5) that also incorporate weight scales for measuring deposited waste in real-time. This integration of weight measurement directly into the door mechanism distinguishes the present system from prior art and enables precise tracking of waste quantities for billing, capacity management, and verification purposes.

The receiving bin 202 has a fixed volume and/or weight capacity 205. When the bin is full (either by volume or by reaching a predetermined weight threshold), or when manually signaled by the user, the automated access door 203 closes and the bin contents are deposited into the compaction chamber 153 below.

FIG. 5 shows the user interface components of the POP/POS digital payment system kiosk 201 including: a digital screen display 206 for presenting information, prompts, and system status to users; a digital keyboard/display panel 207 for user input; activation button(s) 208 for initiating transactions or confirming actions; deactivation button(s) 209 for canceling transactions or signaling completion; and a payment collection device 210.

The payment collection device 210 may comprise multiple payment modalities including: NFC/contactless readers for tap-to-pay transactions; mobile card terminals accepting credit/debit cards with chip and PIN or magnetic stripe; cash scanners and validators for accepting paper currency; barcode scanners for reading QR codes or data matrix codes from mobile device screens; token systems accepting physical or digital tokens; biometric scanners/readers for fingerprint, facial recognition, iris scanning, or voice recognition authentication; or other automated computer input devices configured to grant access upon successful payment authorization.

### POP/POS Authorization Subsystem

In some embodiments, the POP/POS subsystem includes a payment terminal or account terminal that can accept credentials and produce an authorization signal indicating approval or denial. Examples of credential acceptance include card-present, NFC contactless, token/credential scanning, QR scanning, and account login, and the particular modality is implementation dependent.

### Safety, Fault Handling and Interlocks

In some embodiments, the controller implements a “fail-locked” access policy such that if a required sensor is unavailable or contradictory, the controller commands the door to remain locked and enters a fault state. The fault state may include logging the fault, displaying an out-of-service message, optionally notifying a remote operator, and requiring an authorized reset before resuming normal operation.

### Door Sensor Failure Handling

If the door position sensor indicates an impossible state, becomes unresponsive, or produces signals outside expected timing windows, the controller transitions the system to a fault state and commands the lock actuator to lock. In embodiments, if the door is physically open when the fault is detected, the system may (i) inhibit counting, (ii) issue a local alarm, and (iii) disallow further authorizations until the door is closed and an authorized reset is performed.

### Lock Sensor Disagreement Handling

In some embodiments, the system includes a lock-position sensor that indicates whether the lock is engaged or disengaged. If the controller commands unlock but the lock-position sensor indicates “locked,” or if the controller commands lock but the lock-position sensor indicates “unlocked,” the controller enters a fault state, prevents continued user access, and generates a maintenance alert and/or service notification.

### Emergency Stop Behavior

In some embodiments, an emergency stop input immediately disables at least one of (i) door motion actuation (if present), (ii) compactor actuation (if integrated), and (iii) other powered motion, while commanding the access door to a safe state (typically locked when feasible).

In some embodiments, clearing the emergency stop does not automatically resume operation, and instead the controller requires a deliberate reset action and may require maintenance authentication.

### Optional Weighing and Deposit Management

In some embodiments, the system includes one or more weight sensors (e.g., load cells integrated into a door mounting or receiving bin structure) that produce measured weight values associated with deposits.

In some embodiments, the controller samples weight during a cycle and stores a weight value for that cycle (e.g., a stable weight after door closure) and associates it to the transaction session record.

In some embodiments, the system supports weight-based billing, cycle-based billing, or hybrid billing, with weight values used to compute a final amount for the session.

In some embodiments, the system also uses measured weight as an operational indicator for maintenance or capacity prediction.

### Thermal Monitoring

In some embodiments, the system includes at least one thermal sensor or thermal imaging camera positioned to observe contents of the receiving bin and/or compaction chamber.

In some embodiments, the controller analyzes thermal data to detect thermal signatures exceeding a temperature threshold indicative of hot debris, fire risk, or prohibited materials.

### Example Thresholding and Processing (High Level)

In some embodiments, the controller calculates a “hotspot metric” as a maximum observed temperature within a defined region of interest inside the receiving bin, optionally after applying basic spatial filtering and temporal smoothing across multiple frames.

In some embodiments, the controller compares the hotspot metric to a hazard threshold T_{haz} and uses a time-over-threshold rule (e.g., exceeding T_{haz} for N consecutive frames or for at least X seconds) to reduce false positives.

### Example Calibration and Drift Handling (High Level)

In some embodiments, the system performs calibration by establishing a baseline ambient temperature estimate T_{amb} using (i) an initial power-up sampling window and/or (ii) periodic sampling during known-empty bin conditions, and then evaluates hotspot conditions using ΔT=Tₕₒₜₛₚₒₜ−T_{amb}.

In some embodiments, the system applies a hysteresis band so that once a hazard is declared, the hazard clears only after the hotspot metric falls below a lower clear threshold T_{clear}<T_{haz} for a defined duration.

### Example False-Positive Mitigation

In some embodiments, the controller optionally cross-checks a thermal hazard determination with at least one additional signal, such as a smoke/heat sensor, a door-open timer anomaly, or a camera classification event, and then escalates to a lockout only when one or more corroborating conditions are present.

In some embodiments, the system logs the thermal event and stores a short “event window” of thermal measurements and/or images for operator review.

### Lockout Behavior

In some embodiments, upon detecting a hazard condition, the controller prevents subsequent unlocking of the access door and requires an authorized reset before re-enabling access.

In some embodiments, the authorized reset can be performed by keyed switch, maintenance credential at the HMI, and/or remote authorization through a cloud administrator interface.

### Communications, Buffering and Cloud Services

In some embodiments, the system includes at least one communication interface configured for network communication with remote cloud services.

In some embodiments, the system transmits operational data including transaction records, cycle counts, measured weights (if available), fault codes, and diagnostic reports.

In some embodiments, the system includes local non-volatile storage and buffers data during connectivity loss, and then uploads buffered data after connectivity is restored.

### Offline Queue Integrity (High Level)

In some embodiments, queued payment events are stored with a tamper-evident structure such as a chained hash over sequential records, and each record may include a monotonic counter and timestamp to support later reconciliation.

In some embodiments, if the queue indicates inconsistencies, the controller enters a fault state and requests service.

### Optional Integration With a Commercial Compactor and Compaction Control

In some embodiments, the POP/POS kiosk is integrated with a commercial compactor that includes a compaction chamber and a ram actuator.

In some embodiments, deposited waste is directed from the receiving bin into the compaction chamber, and compacted waste is discharged into a receiver box.

In some embodiments, the compactor can be triggered based on capacity monitoring such as fill level sensors, chamber pressure signatures, or receiver box indicators.

In some embodiments, compaction logic is interlocked so that access is denied (door locked) during compaction actuation, and compaction is inhibited if an emergency stop is active or if safety sensor criteria are not satisfied.

### Diagnostics and Maintenance Operations

In some embodiments, the controller runs periodic diagnostics and/or runs diagnostics at the end of a transaction session, including checks of sensor responsiveness, actuator response verification, communication status, and power status.

In some embodiments, diagnostic results are stored locally and transmitted to cloud services when connectivity is available.

In some embodiments, an authorized maintenance mode enables controlled manual actions such as lock/unlock tests, sensor readouts, and optional manual compaction commands.

In some embodiments, maintenance actions are logged with timestamps and identifiers.

In some embodiments, after each door-closed condition, the controller increments the usage-cycle counter and updates a remaining-cycles display. When the authorized cycle count is reached, the controller locks the door, stores a completion record, and finalizes payment capture (immediately or via queued capture if connectivity is lost after authorization).

### Alternative Embodiments and Variations

In some embodiments, the kiosk may be deployed with different receiving bin sizes, door mechanisms, sensor suites, and communication interfaces, and the multi-cycle authorization concept remains applicable. In embodiments, pricing tiers may map to different authorized cycle counts, different maximum total weight, different time windows, or combinations thereof.

In some embodiments, the system can support different deployment types including stationary compactors with detachable receiver boxes, self-contained mobile compactors, mobile trailers, and truck-mounted units. In some embodiments, power systems may include grid power with backup power and/or battery/solar systems sized for autonomous operation.

FIG. 6 illustrates a detailed flow diagram of the cabinet control subsystems showing PLCs, HMI, sensors, actuators, contactors, relays, and operator override functions.

FIGS. 7-10 illustrate detail operational view flow diagrams of the of the cloud services interface, of the entire system and subsystems, the Customer Use Case Overview and of the normal Operations of the Machine Internal Systems Flow.

### Equipment Monitoring, Diagnostic, and Predictive Maintenance System Architecture Overview

The waste management equipment monitoring, diagnostic, and predictive maintenance system comprises distributed components operating in coordinated fashion as illustrated in FIGS. 11-22 . At the edge (local equipment level), sensor arrays 300 collect real-time operational data from waste compaction systems. This data is transmitted via multi-protocol communication systems to cloud-based services where processing, analysis, storage, and user interface functions are performed. Processed results, alerts, and control commands are transmitted back to local equipment and to operator devices. As shown in FIG. 11, the sensor arrays 300 communicate with edge computing devices via various communication pathways such as the communication pathway for the hydraulic and electrical sensing group 301, the communication pathway for the environmental and structural sensing group 302, and the communication pathway for the position, weight and level sensing group 303.

### Edge Components (Local Equipment)

Each monitored waste compaction system includes:

Sensor Arrays, 300: Multiple sensors continuously measure operational parameters:
a. Hydraulic pressure sensors: Pressure transducers positioned on hydraulic lines supplying the compactor ram measure instantaneous hydraulic pressure during compaction cycles. Typical pressure ranges are 0-3000 PSI for commercial compactors, with sensor sampling rates of 10-100 Hz enabling detailed pressure profile capture.
b. Electrical current sensors: Current transformers or Hall-effect current sensors monitor current draw of hydraulic pump motors (typically 10-50 Amps for commercial systems), door lock actuators (1-5 Amps), and control electronics (0.1-1 Amp). Current measurements detect motor bearing wear, mechanical binding, electrical faults, and power supply issues.
c. Temperature sensors: Thermocouples or RTDs monitor hydraulic fluid temperature (normal range 100-150° F., overheating indicated by temperatures exceeding 180° F.), motor winding temperatures, and ambient temperature affecting equipment performance.
d. Vibration sensors: Accelerometers mounted on hydraulic pumps, motors, or structural components measure vibration levels (typically in units of g-force or frequency spectrum analysis). Elevated vibration or changes in vibration frequency spectra indicate bearing wear, imbalance, or mechanical looseness.
e. Door position sensors: Magnetic reed switches or hall-effect sensors provide binary open/closed status or analog position feedback for door travel distance and speed.
f. Weight sensors: Load cells or strain gauges (capacity typically 0-500 lbs for receiving bins, 0-10,000 lbs. for compaction chambers) measure deposited waste quantities with accuracy of ±0.5-2%.
g. Fill level sensors: Ultrasonic distance sensors (range 0-10 feet typical), laser rangefinders, or mechanical limit switches detect waste accumulation height in compaction chambers.
h. Thermal imaging cameras: Infrared cameras (typical resolution 160×120 to 640×480 pixels, temperature range −20° C. to +600° C., thermal sensitivity <0.05° C.) capture thermal images of receiving bins and compaction chambers at frame rates of 1-30 Hz.
i. Visible-light cameras: Standard video cameras (720 p to 4K resolution) provide visual monitoring for security, verification, and visual diagnostics.

Data Acquisition and Local Processing: A local edge computing device (such as an industrial PC, Raspberry Pi, or embedded processor integrated with the PLC) performs:
a. Data acquisition: Polling sensors at appropriate sampling rates, handling analog-to-digital conversion (ADC), applying calibration corrections, and time-stamping measurements.
b. Local buffering: Storing sensor data in local memory (flash storage, SD cards, or solid-state drives with capacity of 8 -128 GB typical) to handle communication interruptions.
c. Edge analytics: Performing preliminary data processing such as: statistical calculations (mean, variance, min, max), threshold comparisons, change detection, and compression of high-frequency data (e.g., storing summary statistics of 100 Hz pressure data rather than transmitting all samples).
d. Protocol conversion: Converting between sensor interfaces (such as 4-20 mA analog, Modbus RTU, CANbus, Ethernet/IP) and network protocols (such as MQTT, HTTP, WebSocket) for cloud communication.

Communication Gateway: Multi-protocol communication hardware (as described in related Application 1) establishes network connectivity. Communication occurs on schedules balancing data freshness with bandwidth and power consumption:
a. Real-time streaming: Critical parameters (such as thermal imaging during active user transactions) streamed in real-time.
b. Periodic uploads: Sensor data uploaded in batches (e.g., every 60 seconds) for non-critical parameters.
c. Event-triggered uploads: Immediate uploads triggered by anomaly detection (such as pressure anomalies, thermal signatures, or faults).

### Cloud Services Architecture

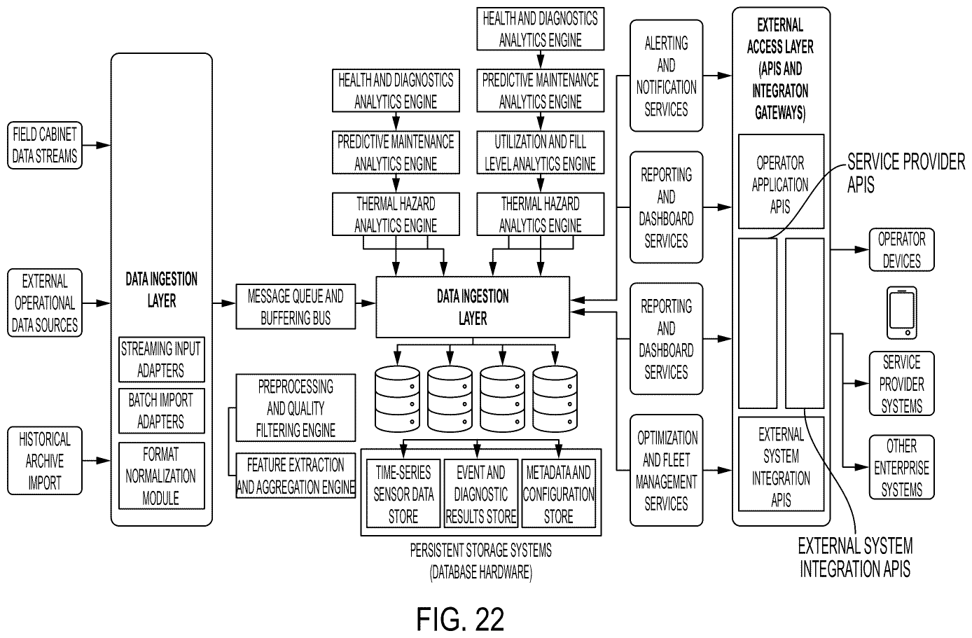

FIG. 22 illustrates the cloud services architecture implementing the monitoring and diagnostic system. The architecture follows modern cloud-native design patterns with microservices, scalable storage, and API-driven interfaces.

### Data Ingestion Layer

IoT Gateway Service: Receives data from edge devices via MQTT, HTTP POST, or WebSocket connections. Handles authentication (via API keys, certificates, or OAuth), validates data format, and routes data to appropriate processing services.
Data Validation Service: Checks received data for completeness, valid ranges, timestamp consistency, and data type correctness. Invalid data is flagged and logged for troubleshooting.
Data Enrichment Service: Augments raw sensor data with contextual information such as equipment configuration (from equipment database), location (from GPS), weather data (from third-party weather APIs), and derived metrics (such as calculating rate-of-change from sequential measurements).

### Data Storage Layer

Time-Series Database: Stores sensor measurements optimized for time-series queries. Technologies such as InfluxDB, TimescaleDB, or AWS Timestream enable efficient storage and retrieval of high-volume time-stamped data. Typical retention policies: raw data retained for 30-90 days; aggregated/down-sampled data retained for 1-5 years.
Relational Database: Stores structured data including equipment records, maintenance history, user accounts, transaction records, and configuration data. Technologies such as PostgreSQL, MySQL, or Amazon RDS.
Document Database: Stores semi-structured data such as diagnostic reports, alert definitions, and configuration documents. Technologies such as MongoDB or Amazon DynamoDB.
Object Storage: Stores binary data including thermal images, video footage, and log files. Technologies such as Amazon S3, Google Cloud Storage, or Azure Blob Storage with lifecycle policies automatically archiving or deleting old data.

### Processing and Analytics Layer

Diagnostic Processing Service: Implements diagnostic algorithms described herein (hydraulic diagnostics, electrical diagnostics, etc.). Executes continuously as new sensor data arrives or on scheduled intervals (e.g., every 15 minutes). Generates diagnostic control outputs that are used by the system to initiate maintenance actions, adjust hydraulic or electrical operating parameters, or place equipment into a reduced-operation or out-of-service state. The hydraulic diagnostic module assigns fault classifications and confidence scores and generates corresponding control outputs that limit allowable operating pressure, reduce compaction frequency, or automatically create high-priority maintenance tickets for the affected system. The electrical diagnostic module flags anomalies and correlates them with actuator operation status . . . and outputs electrical fault control signals that disable further actuation cycles, derate motor operation, or initiate technician dispatch when fault severity exceeds predefined thresholds.
Predictive Maintenance Service: Implements predictive algorithms analyzing degradation trends and calculating remaining useful life. Executes periodically (e.g., daily) or upon request. Generates maintenance recommendations with priority rankings. These recommendations are transmitted as alerts and stored and further used to generate maintenance scheduling control signals that integrate with fleet scheduling and hauling dispatch systems to coordinate maintenance with hauling visits.
Thermal Analysis Service: Processes thermal image data using computer vision algorithms. Identifies thermal signatures, classifies severity, tracks temporal evolution, and generates hazard mitigation control outputs used to disable access control systems, activate fire suppression or ventilation equipment, and notify remote operators. May incorporate data-driven optimization models trained on historical thermal image datasets to improve detection accuracy and to initiate diagnostic responses or maintenance actions.
Fill Level Prediction Service: Analyzes fill level data, transaction patterns, and usage trends to predict time-to-full and generate service dispatch recommendations. Executes continuously, updating predictions as new data arrives.
Analytics Processing Service: Performs batch analytics generating reports, trends, and business intelligence. Executes on scheduled intervals (e.g., nightly) aggregating data across equipment, time periods, and geographic regions.
Data-driven Optimization Pipeline: (Optional advanced embodiment) Implements data-driven workflows and models to process sensor data and generate fault indicators that are used by the system to initiate diagnostic responses or maintenance actions, including: data preparation (feature extraction, normalization), model training (using historical data with labeled outcomes), model validation, and model deployment for predictive analytics. Technologies such as TensorFlow, PyTorch, scikit-learn, or cloud ML services (AWS SageMaker, Google AI Platform, Azure ML).

### Application and API Layer

RESTful API Service: Exposes HTTP APIs enabling client applications (web dashboards, mobile apps) to query data, submit commands, and configure systems. Implements authentication/authorization, rate limiting, and API documentation (such as OpenAPI/Swagger specs).
WebSocket Service: Provides real-time data streaming to connected clients for live dashboards showing real-time sensor readings and alerts.
Notification Service: Generates and delivers alert notifications via multiple channels: email (via SMTP or services like SendGrid), SMS (via Twilio, AWS SNS), push notifications (via Firebase Cloud Messaging, Apple Push Notification Service), and voice calls (via Twilio voice API).
Web Application: Frontend application implementing user interfaces described herein. Built using modern web frameworks (React, Angular, Vue.js) with responsive design supporting desktop and mobile browsers.
Mobile Applications: Native or cross-platform mobile apps (iOS/Android) for field technicians and operators, providing equipment monitoring, diagnostic access, and remote-control capabilities.

### Hydraulic System Diagnostic Module

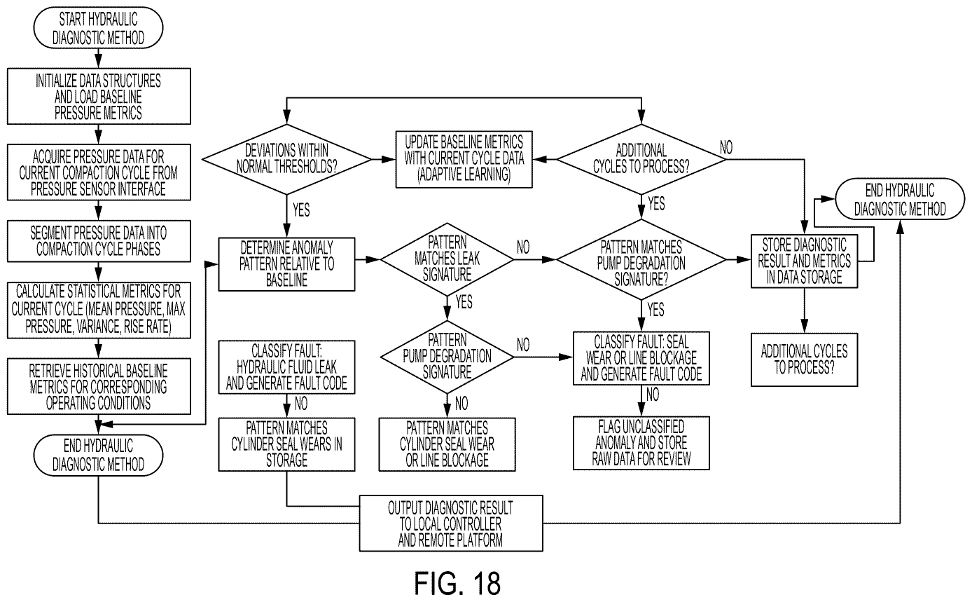

FIG. 18 illustrates the hydraulic system diagnostic algorithm, a key distinguishing feature providing equipment health monitoring specifically designed for hydraulic compaction systems.

### Pressure Profile Acquisition and Analysis

During each compaction cycle, hydraulic pressure sensors sample pressure at high frequency (10-100 Hz typical). A typical compaction cycle pressure profile exhibits characteristic phases:
1. Ram Extension Phase (0-30 seconds typical): Pressure rises from baseline (near zero when ram is retracted) as the hydraulic pump drives fluid into the extension side of the hydraulic cylinder. Initial pressure rise is rapid as fluid accelerates the ram mass. Once the ram contacts accumulated waste, pressure rises more steeply as waste compresses.
2. Compaction Phase (30-60 seconds typical): Ram continues extending, compressing waste against the receiver box or rear wall. Pressure continues rising, potentially reaching maximum system pressure (2000-3000 PSI typical). Pressure plateaus when waste is fully compacted or system pressure relief valve opens.
3. Hold Phase (optional, 1-5 seconds): Some systems maintain pressure briefly at maximum to ensure complete compaction.
4. Ram Retraction Phase (10-20 seconds typical): Hydraulic flow reverses, retracting the ram. Pressure on extension side drops to near zero; pressure on retraction side rises (typically lower than extension pressure due to smaller cylinder area).

The diagnostic module extracts statistical metrics from each pressure profile:
Maximum Pressure (Pmax): Peak pressure achieved during the cycle (PSI).
Mean Pressure (Pmean): Average pressure during the compaction phase (PSI).
Pressure Variance (σ²): Statistical variance of pressure measurements during compaction phase, indicating smoothness/stability of compression (PSI²).
Pressure Rise Rate (dP/dt): Maximum rate of pressure increase during initial compression phase (PSI/second), indicating pump performance and system responsiveness.
Time to Maximum Pressure (tmax): Duration from cycle start to reaching maximum pressure (seconds), indicating waste compressibility and system efficiency.
Pressure Integral (∫P dt): Area under the pressure-time curve, representing total energy expended during compaction (PSI·seconds), correlating with waste quantity and density.

These metrics are stored in the time-series database along with timestamps and equipment identifiers.

### Baseline Establishment and Anomaly Detection

During initial system deployment or after maintenance service, the system operates through a baseline establishment period (typically 50-200 compaction cycles). Statistical baselines are calculated for each metric:
Baseline Mean (μ): Average value of the metric over baseline cycles.
Baseline Standard Deviation (σ): Standard deviation of the metric over baseline cycles.
Baseline Range: Minimum and maximum values observed during baseline period.

For each subsequent compaction cycle, current metrics are compared to baselines using anomaly detection algorithms:
1. Statistical Threshold Method: A metric value is flagged as anomalous if it deviates from baseline mean by more than a threshold number of standard deviations (typically 2-3 σ). For example: if Pmax baseline is μ=2500 PSI with σ=200 PSI, then Pmax>3100 PSI (μ+3σ) or Pmax<1900 PSI (μ-3σ) triggers an anomaly flag.
2. Rate-of-Change Method: A metric is flagged if its rate of change over time (comparing recent average to earlier average) exceeds a threshold. For example: if mean Pmax over the last 10 cycles is 10% lower than mean Pmax 100 cycles ago, this indicates degradation.
3. Multi-Metric Correlation: Some fault conditions produce correlated changes in multiple metrics. For example, hydraulic fluid leaks typically cause declining Pmax, declining dP/dt, and increased tmax simultaneously. The diagnostic module evaluates metric combinations for correlated anomalies, increasing detection confidence.

### Fault Classification

When anomalies are detected, the diagnostic module classifies the likely fault condition based on specific metric patterns:
1. Hydraulic Fluid Leak:
   Signature: Progressive decline in Pmax and dP/dt over many cycles (days to weeks).
   Mechanism: Fluid escaping through seal wear, line cracks, or connection failures reduces system pressure capacity.
   Detection: Linear regression on Pmax over sliding window (e.g., last 100 cycles) with negative slope exceeding threshold (e.g., −5 PSI/day) indicates leak.
   Confidence Factors: Confidence increases if: (a) multiple pressure metrics decline; (b) hydraulic fluid temperature increases (less fluid=less cooling capacity); (c) pump run time per cycle increases (pump runs longer to achieve same pressure).
2. Hydraulic Pump Degradation:
   Signature: Declining dP/dt (slower pressure rise) and increased tmax with stable or declining Pmax.
   Mechanism: Pump wear (worn vanes, gears, or pistons) reduces volumetric efficiency and flow rate.
   Detection: dP/dt declining below baseline by more than 20% while Pmax remains within baseline range suggests pump degradation rather than leak.
   Confidence Factors: Confidence increases if electrical current measurements show increased motor current draw (motor working harder due to mechanical wear).
3. Hydraulic Cylinder Seal Wear:
   Signature: Increased pressure variance (σ²) during compaction phase, indicating pressure instability.
   Mechanism: Worn piston seals allow internal leakage across piston, causing pressure fluctuations as fluid bypasses seals.
   Detection: σ² exceeding baseline by factor of 2-3×while Pmax remains relatively stable.
   Confidence Factors: Confidence increases if visible external fluid leakage is not present (ruling out external leak) and if pressure instability worsens during hold phase when static pressure exposes seal degradation.
4. Hydraulic Line Blockage:
   Signature: Abnormally high Pmax (exceeding baseline upper limit) with reduced dP/dt and increased tmax.
   Mechanism: Partial blockage (such as contamination, kinked hoses, or valve malfunction) restricts fluid flow, causing pressure spikes and slow response.
   Detection: Pmax>μ+3σ combined with dP/dt<μ-2σ.
   Confidence Factors: Confidence increases if blockage occurred suddenly (step change in metrics) rather than gradually (suggesting installation issue or acute failure rather than progressive wear).
5. System Overload/Excessive Waste Quantity:
   Signature: Elevated Pmax, increased tmax, and elevated pressure integral (∫P dt) indicating larger or denser waste load.
   Mechanism: Not a fault condition but indicates exceptional waste quantity or difficult-to-compress materials.
   Detection: Pmax>μ+2σ with proportional increase in ∫P dt, occurring intermittently rather than progressively.
   Action: Informational alert to operators; may trigger additional compaction cycles or adjust operational parameters.

Fault classifications are stored with confidence scores (0-100%) based on how closely observed patterns match expected signatures. Multiple anomalies may indicate multiple concurrent faults or single root cause with cascading effects (e.g., leak causing pump to work harder, accelerating pump wear).

### Actionable Maintenance Recommendations

For each identified fault, the diagnostic module generates maintenance recommendations:
Fault Description: Human-readable description (e.g., “Hydraulic fluid leak detected based on declining maximum pressure over 15 days”).
Affected Components: Specific components requiring inspection or service (e.g., “Hydraulic hoses, cylinder seals, pump seals, fittings”).
Severity Level: Categorized as Low, Medium, High, or Critical based on deviation magnitude and failure risk.
Recommended Actions: Specific service tasks (e.g., “Inspect all hydraulic connections for external fluid presence; pressure test system with ram disconnected to isolate leak location; replace failed components”).
Estimated Time to Failure: If degradation trend continues, projected time until system failure (e.g., “Estimated 7-14 days until pressure insufficient for compaction”).
Supporting Data: Links to relevant pressure profile graphs, statistical analysis, and historical trends for technician review.

These recommendations are transmitted as alerts (described later) and stored in equipment maintenance history for tracking and compliance.

### Electrical System Diagnostic Module

Parallel to hydraulic diagnostics, the electrical system diagnostic module monitors electrical current draw of motors and actuators.

### Motor Current Signature Analysis (MCSA)

Electric motors driving hydraulic pumps exhibit characteristic current draw patterns:
Startup current: Inrush current during motor start (typically 3-7×rated current for 0.1-0.5 seconds) accelerating motor and pump to operating speed.
Running current: Steady-state current during operation (typically near rated current, e.g., 20-30 Amps for a 10 HP motor at 230V).
Load-dependent variation: Current increases proportionally to load (hydraulic pressure, hence waste compression resistance).

Anomalies indicating faults:
Elevated baseline current: Current draw exceeding rated current during normal operation indicates mechanical issues such as bearing wear (increasing friction), shaft misalignment, or motor winding faults.
Current fluctuations: Oscillating current at frequencies other than line frequency (50/60 Hz) or motor pole pass frequency indicates bearing defects (producing characteristic bearing defect frequencies calculable from bearing geometry and rotation speed).
Asymmetric Phase Currents: for Three-phase Motors, Imbalance Among Phase currents exceeding 10% indicates winding faults or supply voltage imbalance.
Reduced current capacity: Inability to draw sufficient current to produce rated power indicates motor overheating (thermal protection reducing capacity), winding damage, or supply voltage sag.

### Actuator Current Monitoring

Door lock actuators and other solenoid/motor-driven actuators exhibit binary operation (energized/de-energized):
Normal current: Actuator draws rated current (e.g., 2 Amps) when energized, near-zero when de-energized.
Mechanical binding: Elevated current (e.g., 3-4 Amps) indicates actuator struggling against mechanical resistance (such as misalignment, debris, or mechanical damage).
Electrical failure: No current draw when commanded energized indicates open circuit (broken wire, faulty connection, or burned-out coil).
Short circuit: Excessive current draw (exceeding circuit breaker/fuse rating) immediately upon energization indicates shorted windings.

The electrical diagnostic module flags anomalies and correlates them with actuator operation status (successful/failed actuation detected by position sensors) to distinguish mechanical vs. electrical faults.

### Predictive Maintenance Module

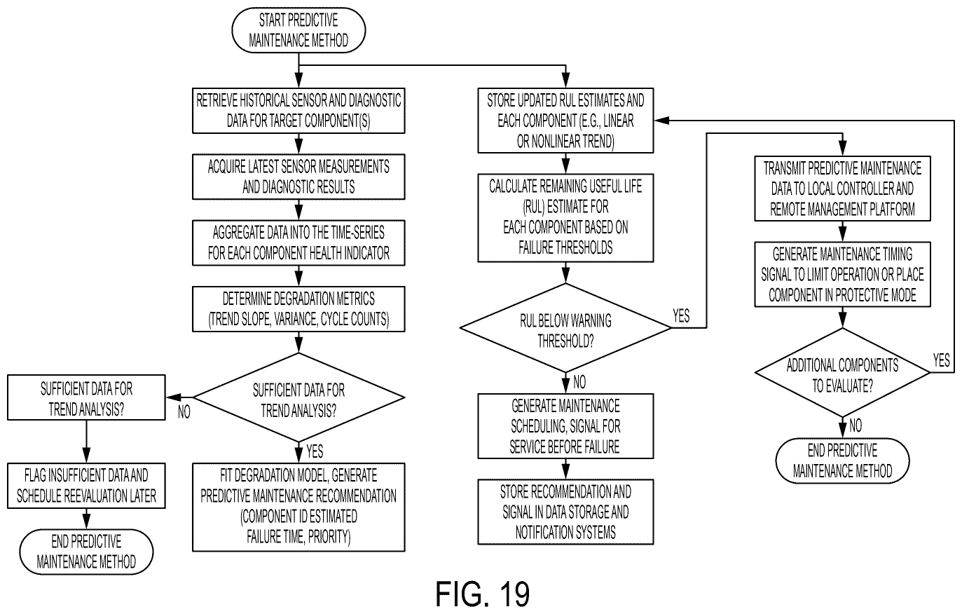

FIG. 19 illustrates the predictive maintenance algorithm, which extends beyond reactive diagnostics (detecting current faults) to proactive predictions (forecasting future failures).

### Degradation Trend Extraction

For metrics exhibiting progressive degradation (such as declining hydraulic pressure or increasing bearing vibration), the predictive maintenance module performs time-series trend analysis:
Data Windowing: Select a historical window of data (e.g., last 1000 compaction cycles or last 90 days) representing recent operational period.
Trend Fitting: Apply regression algorithms to model the metric's behavior over time:
   Linear regression: Fit a straight line (metric=m·time+b) appropriate for constant-rate degradation.
   Polynomial regression: Fit polynomial curves for accelerating/decelerating degradation.
   Exponential regression: Fit exponential curves (metric=a·e\hat{ }(k·time)) for failure modes following exponential decay.
Goodness-of-Fit Evaluation: Calculate R² coefficient indicating how well the trend model fits observed data. High R² (>0.7) indicates clear degradation trend; low R² suggests random variation without clear trend.
Extrapolation: Extend the trend model into the future to predict future metric values at specific times.

### Remaining Useful Life (RUL) Calculation

For components with known failure thresholds, RUL is calculated by determining when the extrapolated trend will cross the failure threshold:

### Example: Hydraulic Pump RUL

Failure Threshold: Maximum pressure (Pmax)<1500 PSI indicates pump can no longer generate sufficient pressure for effective compaction (operationally defined failure).
Current Condition: Pmax currently averaging 2200 PSI.
Degradation Rate: Trend analysis shows Pmax declining at −10 PSI/day (linear regression with R²=0.85).
RUL Calculation: (Current Pmax−Failure Threshold)/Degradation Rate=(2200−1500)/10=70 days estimated RUL.
Confidence: R² value and historical data volume inform confidence estimate (e.g., “70 days±15 days with 80% confidence”).

The predictive maintenance module calculates RUL for multiple components:
Hydraulic pump: Based on pressure metrics.
Hydraulic cylinder seals: Based on pressure variance metrics.
Motor bearings: Based on vibration or current signature metrics.
Door actuators: Based on cycle counts (mechanical components with defined cycle life, e.g., “actuator rated for 100,000 cycles, current count 75,000, estimated 25,000 cycles remaining at current usage rate=120 days RUL”).

### Maintenance Scheduling Recommendations

Generated maintenance recommendations include:
Component Identification: Which component requires service.
Estimated RUL: Time until predicted failure (days, weeks, or months).
Recommended Service Date: RUL minus a safety margin (e.g., service recommended at 75% of RUL to ensure service occurs before failure).
Priority Ranking: Based on RUL, criticality of component (e.g., hydraulic pump failure disables entire system vs. door light failure has minimal impact), and service logistics (e.g., components serviceable during same maintenance visit are grouped).
Cost Estimates: Integration with parts databases and labor rate tables provides estimated service costs.

### Thermal Hazard Detection Module

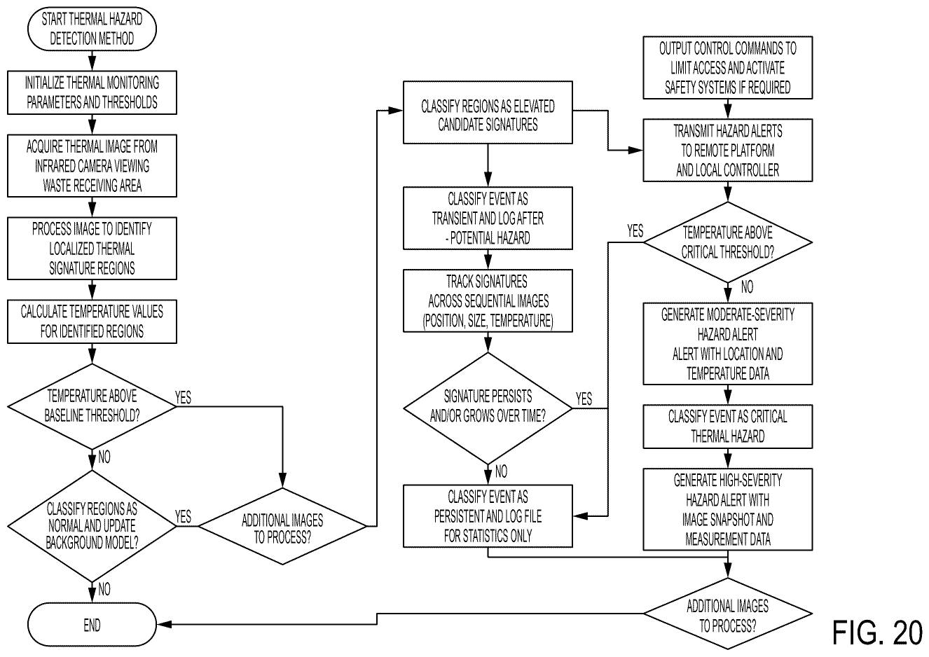

FIG. 20 illustrates the thermal hazard detection algorithm, addressing a critical safety concern for unattended autonomous waste compaction: detection of hazardous materials deposited by users.

### Thermal Image Acquisition

Infrared thermal imaging cameras positioned to view receiving bins capture thermal images at regular intervals (1-10 Hz typical) whenever the receiving bin door is open or immediately after closure. Each thermal image is a 2D array of temperature values (one temperature per pixel).

### Thermal Signature Identification

The thermal analysis service processes thermal images to identify localized thermal signatures:
1. Background Subtraction: Calculate baseline background temperature (typically the average temperature of the bin interior walls and empty space, approximately ambient temperature 60-80° F.). Subtract background from all pixels.
2. Threshold Application: Identify pixels exceeding a temperature threshold above background (e.g., +50° F. above background). Pixels exceeding threshold are candidate thermal signature pixels.
3. Connected Component Analysis: Group adjacent pixels exceeding threshold into contiguous regions (thermal signatures). Each signature is characterized by:
   Centroid location: (x, y) coordinates of signature center.
   Spatial extent: Area (number of pixels) and bounding box dimensions.
   Temperature statistics: Maximum temperature, mean temperature, temperature variance within signature.

Signature Classification: Classify each thermal signature by maximum temperature:
Normal: T<130° F. (warm but not hazardous; may be normal hot food waste, recently sun-heated items, etc.).
Elevated: 130° F.≤T<200° F. (significantly above normal; potential concern).
Critical: T≥200° F. (dangerous; charcoal, ashes, exothermic reactions, incipient combustion).

### Temporal Analysis

Thermal signatures are tracked across sequential images over time (seconds to minutes) to assess hazard persistence and growth:
1. Signature Tracking: Match thermal signatures in consecutive images based on spatial proximity of centroids. A signature in frame N is considered the same signature in frame N+1 if centroids are within a tracking radius (e.g., 10 pixels) and temperature is similar (within 20° F.).
2. Persistence Detection: Count how many consecutive frames a signature persists at the same location. Transient signatures (persisting <5 frames/<5 seconds) are likely non-hazardous (such as brief hot spots from waste settling). Persistent signatures (persisting >5 seconds) indicate heat-generating materials.
3. Growth Detection: Calculate whether signature spatial extent or temperature is increasing over time:
   Spatial growth: Signature area increasing by >20% between frames indicates spreading.
   Thermal growth: Maximum temperature increasing by >10° F./minute indicates intensifying heat generation or combustion.

### Temporal Event Classification

Transient: Signature persists <5 seconds→likely non-hazardous, no alert.
Persistent: Signature persists >5 seconds without growth→elevated concern, generate warning alert.
Growing: Signature exhibits spatial or thermal growth→critical concern, generate critical alert and activate suppression.

### Hazard Alert Generation and Control Integration

Based on thermal signature classification and temporal analysis, the thermal hazard detection module generates alerts and control commands:

### Warning Alerts (Elevated, Persistent Signatures)

Alert notification transmitted to monitoring personnel: “Elevated thermal signature detected at Equipment ID #12345, Location: Park Station 7, Temperature: 165° F., Persistent for 12 seconds.”
Thermal image attached to alert for visual inspection.
No automated control action; operators review and determine if on-site inspection is warranted.

### Critical Alerts (Critical or Growing Signatures)

Immediate critical alert transmitted via multiple channels (SMS, phone call, push notification): “CRITICAL: Fire hazard detected at Equipment #12345. Temperature: 245° F. and rising. Fire suppression activating.”

Control commands transmitted to local equipment:
Disable access control: Lock door and prevent further waste deposition by disabling payment/unlock functions. HMI displays “Out of Service—Fire Hazard Detected”.
Activate fire suppression: If equipped with automated suppression (such as CO₂ or dry chemical extinguishers), trigger suppression system to extinguish fire before it spreads.
Activate ventilation: Open vents or activate fans to dissipate heat and smoke.

Notify emergency services: Optionally automatically dial 911 or fire department with pre-recorded message providing equipment location and hazard description.

### User Identification and Accountability

The system correlates thermal hazard events with transaction records to identify which user deposited hazardous materials. Transaction records include timestamp, payment method, and potentially user identification (if using account-based access or video facial recognition).

This correlation enables follow-up enforcement actions (fines, account suspension, criminal referral for egregious violations) and deterrence of improper disposal.

### Distinguishing From Prior Art Fire Detection

This thermal hazard detection system provides significant advantages over prior art:

The '151 patent discloses facility-wide fire monitoring but provides no disclosure of thermal imaging at the individual disposal event level with user correlation.

Prior art fire detection systems react to fires after ignition (smoke, flame, heat); the present system detects hazardous conditions before ignition (hot materials deposited) and prevents ignition through immediate intervention.

Integration with access control (disabling further waste deposition) addresses the specific problem of unattended autonomous operation where continued operation during thermal hazards would be unsafe.

Temporal analysis (persistence and growth detection) reduces false positives compared to simple temperature threshold systems.

### Fill Level Prediction and Service Dispatch Module

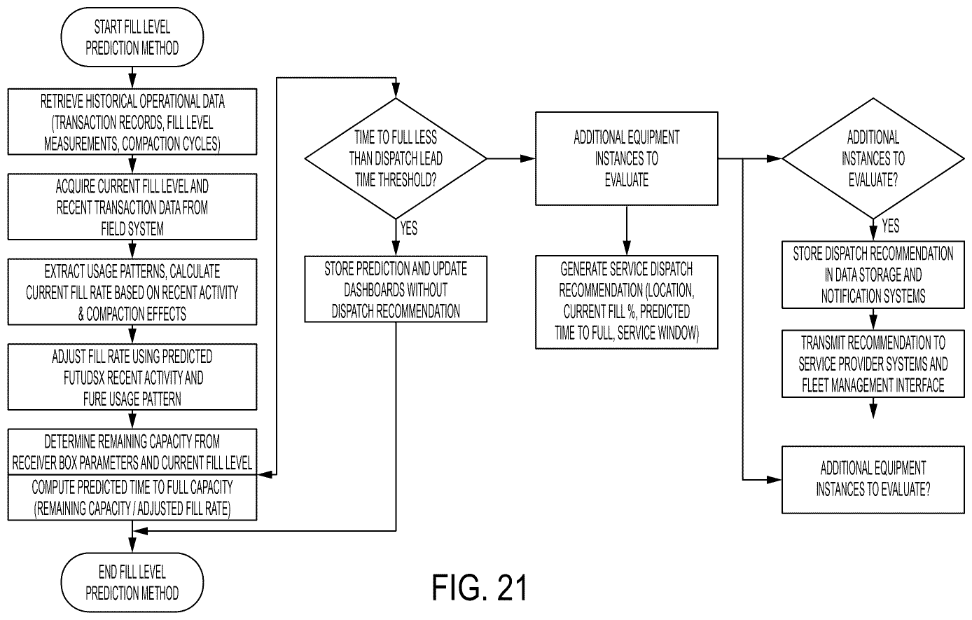

FIG. 21 illustrates the fill level prediction method executed by a processor enabling optimized logistics for waste hauling services.

### Usage Pattern Extraction

The fill level prediction service analyzes historical transaction and fill level data to identify usage patterns:
1. Time-of-Day Analysis: Aggregate transaction counts by hour of day over a historical period (e.g., last 30 days). Calculate average transaction rate for each hour (e.g., 5 AM: 0.2 transactions/hour; 12 PM: 2.5 transactions/hour; 8 PM: 1.0 transactions/hour). This reveals daily usage peaks (e.g., lunchtime at commercial locations, evenings at public park locations).
2. Day-of-Week Analysis: Aggregate transaction counts by day of week. Calculate average transaction rate for each day (e.g., Monday: 25 transactions/day; Saturday: 45 transactions/day). This reveals weekly usage patterns (e.g., weekend peak usage at recreation areas, weekday peak at commercial areas).
3. Seasonal and Special Event Analysis: (Advanced embodiment) Incorporate calendar data identifying holidays, local events, weather conditions, etc. that influence waste generation. For example, usage at park compactors increases on holiday weekends; usage at construction site compactors decreases during rain.
4. Waste Quantity Patterns: Analyze not just transaction frequency but also waste quantities per transaction (weight or volume). Some users deposit small amounts (single bags), others deposit large amounts (truckloads at commercial sites). Average deposit quantity varies by location and user type.

### Current Fill Rate Calculation

The prediction service calculates current fill rate (percentage fill increase per unit time):
1. Recent Fill Level Delta: Compare current fill level (from latest fill sensor reading, e.g., 65% full) to fill level at a recent past time (e.g., 24 hours ago: 55% full). Delta=65%-55%=10% fill increase over 24 hours.
2. Recent Transaction Count: Count transactions during the same period (e.g., 30 transactions in past 24 hours).
3. Fill Rate per Transaction: Delta/Transaction Count=10%/30=0.33% fill increase per transaction.
4. Transaction Rate: Transaction Count/Time Period=30/24 hours=1.25 transactions/hour.
5. Current Fill Rate: Fill Rate per Transaction×Transaction Rate=0.33%×1.25 transactions/hour=0.41% fill increase per hour.
   Note: This calculation accounts for compaction cycles (which reduce fill level). If a compaction cycle occurred during the measurement period, the fill level delta already reflects the net effect (deposits minus compaction reduction).

### Predicted Fill Rate Adjustment

Current fill rate is adjusted based on predicted future usage patterns to improve accuracy:
Time-of-Day Adjustment: If the current time is 3 PM and the current fill rate calculation used data from the past 24 hours (including nighttime with low usage), but the next 6 hours (3 PM-9 PM) historically have higher usage, adjust fill rate upward based on evening usage patterns.
   Example: If evening hours (3 PM-9 PM) historically have 150% of average daily usage rate, multiply current fill rate by 1.5: 0.41%×1.5=0.62% predicted fill rate for next 6 hours.
Day-of-Week Adjustment: If today is Friday and weekend usage is historically higher, adjust fill rate for the upcoming weekend period.

### Time-to-Full Calculation

With predicted fill rate, calculate time until full capacity:
Capacity Remaining: 100%−Current Fill Level=100%−65%=35% remaining capacity.
Time to Full: Capacity Remaining/Predicted Fill Rate=35%/0.62% per hour=56 hours.

This is the predicted time until the compaction chamber reaches 100% full and compaction cycles can no longer make space (receiver box is full).

### Service Dispatch Recommendation

The service dispatch recommendation module compares predicted time-to-full against dispatch lead time requirements:
Dispatch Lead Time Threshold: Configured parameter (e.g., 48 hours) representing minimum time required to schedule and execute a waste hauling service visit (allowing for scheduling, travel, and logistics).
Recommendation Logic:
   If Time-to-Full>Dispatch Lead Time Threshold: No action needed; monitor continues.
   If Time-to-Full≤Dispatch Lead Time Threshold: Generate service dispatch recommendation.
Service Dispatch Recommendation Content:
   Equipment ID and Location (GPS coordinates, address).
   Current Fill Level (65%).
   Predicted Time to Full (56 hours).
   Recommended Service Window (e.g., “Within next 48 hours”).
   Estimated Waste Weight (based on compaction ratios and fill level, e.g., “Approximately 2.5 tons”).
   Access Instructions (if special access required).
Transmission: Recommendation transmitted to waste hauling service provider's dispatch system (via API integration, email, or SMS) enabling proactive scheduling.

### Advantages Over Prior Art

This predictive approach provides advantages over:
Prior art systems using simple threshold alerts (e.g., “80% full→schedule service”) which don't account for usage rates and may result in either premature service visits (waste of hauling resources) or late service visits (equipment fills and becomes unavailable).
The '920 publication which tracks weight for billing but provides no disclosure of predictive algorithms for logistics optimization.
Manual scheduling approaches requiring personnel to physically inspect equipment fill status.

The predictive approach enables just-in-time service scheduling, minimizing both equipment unavailability (from overfilling) and service visit frequency (reducing hauling costs).

### Fleet Management and Optimization

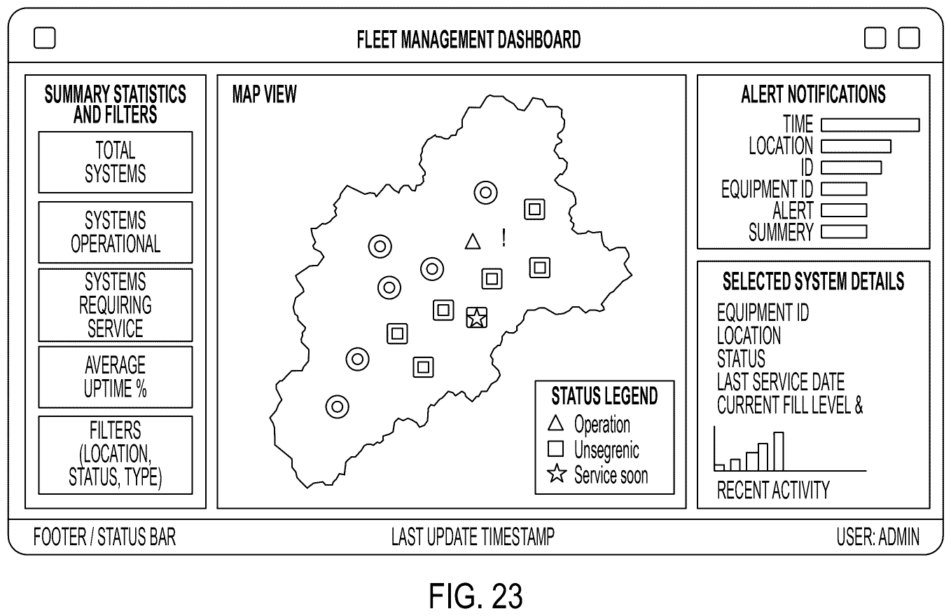

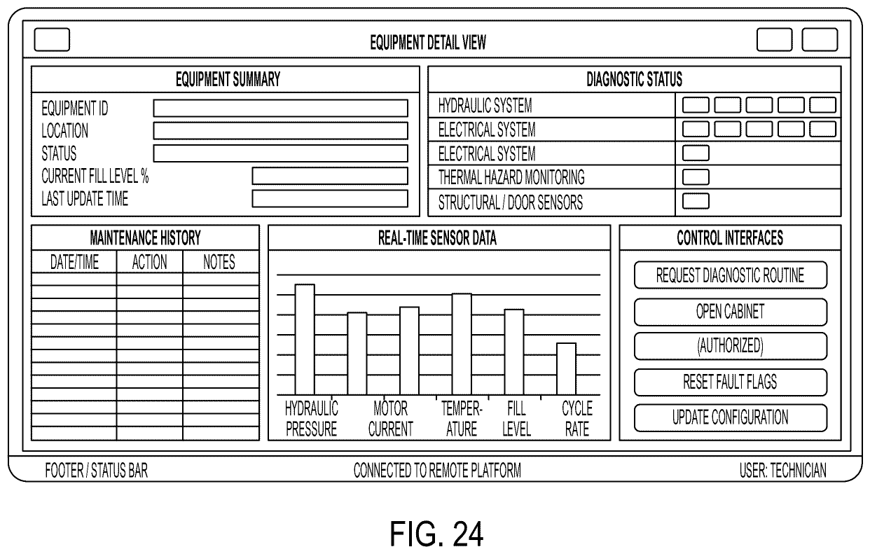

FIGS. 23-24 illustrate user interface components of the fleet management system for operators deploying multiple waste compaction systems.

### Map Visualization Dashboard (FIG. 23)

The web-based fleet management dashboard presents a map view (using mapping APIs such as Google Maps, Mapbox, or OpenStreetMap) showing geographic locations of all deployed equipment units. Each unit is represented by a marker icon on the map, color-coded by operational status:
Green: Operational (no faults detected, fill level <70%, all systems nominal).
Yellow: Service needed soon (predictive maintenance recommendations pending, fill level 70-85%, or minor faults detected).
Red: Urgent service required (critical faults, fill level >85%, or out-of-service status).
Gray: Offline (communication lost, powered off, or decommissioned).

Map controls enable:
Zoom and Pan: Navigate to different geographic regions.
Filter: Show/hide units by status, location, or other criteria.
Clustering: When zoomed out with many nearby units, cluster overlapping markers showing count (e.g., “5 units” cluster marker), expanding when zoomed in to show individual units.
Click for Details: Clicking a unit marker opens a summary popup showing: Equipment ID, location address, current status, fill level percentage, last communication timestamp, and a “View Details” link.

Summary statistics are displayed in dashboard panels:
Fleet Overview: Total units deployed, units operational, units requiring service, units offline.
Current Alerts: Count of critical alerts, warning alerts, and informational notifications across the fleet.
Today's Activity: Total transactions processed, total waste volume/weight collected, total revenue generated.
Service Queue: Number of service dispatch recommendations pending, estimated service workload (hours or visits).

### Equipment Detail View (FIG. 24)

Clicking “View Details” on any equipment unit opens a detailed view with multiple tabs/sections:

### Real-time Sensor Data Tab

Live display of current sensor readings updating every 1-60 seconds: hydraulic pressure, motor current, temperatures, fill level, door status, battery voltage, GPS location.
Graphical gauges, bar charts, or numeric displays with color-coding (green=normal, yellow=warning, red=critical).
Historical trend graphs showing sensor data over selectable time periods (last hour, last day, last week, last month).

### Diagnostic Status Tab

Summary of most recent diagnostic results: timestamp, overall health score (0-100%), subsystem health indicators (hydraulic system, electrical system, sensors, communications).
List of detected faults with severity, description, affected components, and timestamps.
List of active alerts that have been generated but not yet resolved/acknowledged.
Diagnostic history log showing past faults, resolution dates, and maintenance actions taken.

### Maintenance History Tab

Chronological log of all maintenance events: scheduled maintenance, predictive maintenance actions, reactive repairs.
For each event: date, technician, work performed, parts replaced, labor hours, costs.
Next scheduled maintenance date and recommended service tasks.
Component lifecycle tracking showing cycle counts or operating hours for key components with remaining useful life estimates.

### Transaction History Tab

Searchable/filterable list of all transactions processed by this equipment.
For each transaction: timestamp, transaction ID, payment method, amount, cycles used, weight deposited, user ID (if available).
Export functionality (CSV, Excel, PDF) for accounting and reporting.
Revenue analytics: total revenue, revenue trends, average transaction value.

### Control Interface Tab

Remote control capabilities (requires elevated permissions/authentication):
Lock/Unlock Door: Manually command door lock state for maintenance or emergency access.
Trigger Compaction: Manually initiate compaction cycle for testing or off-schedule compaction.
Reset System: Reboot PLC or reset fault flags after service.
Update Configuration: Adjust operational parameters (pricing, cycle limits, thresholds, schedules).
Enable/Disable: Take system out of service or return to service.
Live Video Feed: View live or recent video footage from installed cameras (if enabled).
Communication Test: Send test messages to verify cloud connectivity.
Comparative Analytics Module
   The fleet management system aggregates data across all deployed units to generate comparative analytics:
Performance Rankings:
   Rank units by metrics such as: uptime percentage (highest to lowest), revenue per day, transactions per day, average transaction value, maintenance cost per transaction.
   Identify top performers and underperformers for operational optimization.
Outlier Detection:
   Calculate fleet-wide statistics (mean, standard deviation) for key metrics.
   Identify outlier units where metrics deviate significantly from fleet averages (e.g., >2 standard deviations).

Examples:
High Maintenance Cost Outlier: Unit #457 maintenance cost is $2,500/month vs. fleet average $800/month→investigate why this unit requires excessive service.
Low Revenue Outlier: Unit #203 revenue is $150/week vs. fleet average $600/week →investigate if location has insufficient demand, pricing is wrong, or equipment is malfunctioning causing user dissatisfaction.
High Fill Rate Outlier: Unit #891 fills in 2 days vs. fleet average 7 days→indicates high-demand location; may warrant larger capacity unit or more frequent service.

### Correlation Analysis

Analyze correlations between operational factors and performance:
Does equipment age correlate with maintenance cost?
Does geographic location type (urban vs. rural, commercial vs. residential) correlate with revenue?
Does weather (temperature, precipitation) correlate with usage patterns?
Does pricing correlate with usage volume (elasticity analysis)?

These insights inform deployment strategy, pricing optimization, and equipment specifications.

### Maintenance Coordination Module

The fleet management system consolidates service dispatch recommendations from individual units and optimizes maintenance technician routing:

### Service Request Consolidation

Aggregates all pending service dispatch recommendations (from fill level predictions) and maintenance alerts (from diagnostic modules).
Prioritizes by urgency: Critical (equipment out of service)>High (RUL <7 days or fill >90%)>Medium (RUL 7-30 days or fill 80-90%)>Low (routine scheduled maintenance).

### Geographic Clustering

Groups service requests by geographic proximity (e.g., all units within a 10-mile radius).
Enables efficient routing where a single service visit can service multiple nearby units.

### Technician Assignment

Considers technician factors:

Current Location: Minimize travel distance/time.

Availability: Check technician schedules for available time slots.

Skills: Match technician qualifications to service requirements (e.g., hydraulic system repair requires certified technician; routine waste removal requires general field technician).

Equipment: Ensure technician has necessary tools, parts, and vehicle capacity (waste hauling requires appropriate truck).

### Work Order Generation

Automatically generates work orders containing:
Equipment ID, location (GPS+address), access codes/instructions.
Service tasks required (from diagnostic recommendations).
Estimated labor hours and parts required.
Priority level and recommended completion timeframe.
Transmits work orders to technician mobile devices (via mobile app or SMS/email).

### Route Optimization

For multi-stop service visits, calculates optimal routing sequence minimizing total travel time/distance using routing algorithms (traveling salesman problem solvers).
Provides turn-by-turn navigation integration with mapping apps.

### Business Intelligence and Optimization Recommendations

The fleet management system provides strategic insights for business optimization:

### Demand Analysis

Identifies geographic areas with high transaction density indicating strong demand.
Identifies areas with deployed equipment experiencing underutilization indicating weak demand.
Recommends equipment relocation from low-demand to high-demand areas.
Identifies geographic gaps (areas without deployed equipment but with potential demand based on demographics, nearby facilities, etc.) recommending new deployment locations.

### Capacity Optimization

Analyzes whether deployed equipment capacity (compaction chamber size, receiver box capacity) matches demand at each location.
Recommends capacity upgrades (larger units) at high-demand locations to reduce service frequency.
Recommends capacity downgrades (smaller units) at low-demand locations to reduce equipment costs.

### Pricing Optimization

Analyzes price sensitivity (elasticity) by testing different pricing levels at different locations or times.
Recommends optimal pricing strategies: uniform pricing, location-based pricing (higher prices at high-demand/low-supply locations), time-based pricing (peak pricing during high-demand periods), or volume discounts (lower per-cycle price for larger purchases).

### Preventive Maintenance Scheduling

Analyzes maintenance history across fleet to identify optimal preventive maintenance intervals.
   Example: If analysis shows hydraulic pump failures occur on average at 5,000 compaction cycles, recommend preventive pump service at 4,000 cycles across all units.

### Financial Reporting

Comprehensive profit/loss analysis per equipment unit and fleet-wide.
Revenue breakdown by location, time period, payment method.
Cost breakdown: equipment capital costs, maintenance/repair costs, service/hauling costs, communication/software costs.
ROI calculations informing equipment investment decisions.

### Data-Driven Optimization and Advanced Analytics (Optional Embodiment)

Advanced embodiments of the system incorporate data-driven optimization models for enhanced predictive capabilities and are executed to process sensor data and generate fault indicators that are used by the system to initiate diagnostic responses or maintenance actions:

### Supervised Learning for Fault Prediction

Training data consists of historical sensor data labeled with known fault outcomes (e.g., “hydraulic pump failed after 30 days”).
A control system comprising a processor configured to execute a trained model to process time-series sensor data and generate a failure-indicator signal, the control system being further configured to modify at least one operational parameter of the system based on the failure-indicator signal to mitigate component degradation.
Trained models predict failure probability based on current sensor data, potentially detecting subtle patterns not captured by rule-based diagnostic algorithms.

### Anomaly Detection Using Unsupervised Learning

Unsupervised algorithms (such as isolation forests, autoencoders, or clustering algorithms) establish baseline operational metrics from historical data and generate anomaly indicators when real-time sensor measurements deviate from stored baseline operational metrics beyond predefined thresholds.
Real-time sensor data is compared to stored baseline operational metrics; deviations indicate anomalies.
This approach can detect novel fault modes not explicitly programmed, improving system robustness.

### Time-Series Forecasting for Usage Prediction

Time-series models (such as ARIMA, Prophet, or LSTM neural networks) are executed to generate projected usage metrics that are used to automatically schedule waste hauling or adjust service intervals.
More accurate usage predictions improve fill level prediction accuracy and generate projected fill-level values that are used to automatically transmit service dispatch commands or adjust service intervals.

### Computer Vision for Thermal Image Analysis

Convolutional neural networks (CNNs) trained on thermal image datasets classify thermal signatures with higher accuracy than rule-based algorithms.
Models can distinguish between benign thermal signatures (such as hot food waste) and hazardous signatures (such as smoldering charcoal) based on spatial patterns, temperature distributions, and temporal evolution.

### Reinforcement Learning for Pricing Optimization

Control agents iteratively adjust pricing parameters within predefined operational constraints of waste compaction equipment availability and service capacity.

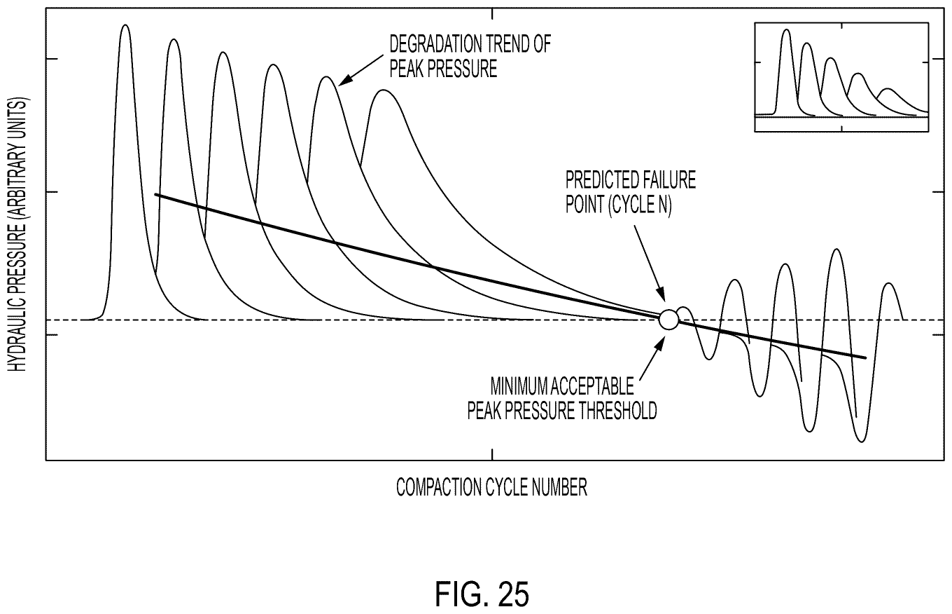

### FIG. 25

Illustrative graph showing example hydraulic pressure data over multiple compaction cycles with annotated baseline, degradation trend, and predicted failure point

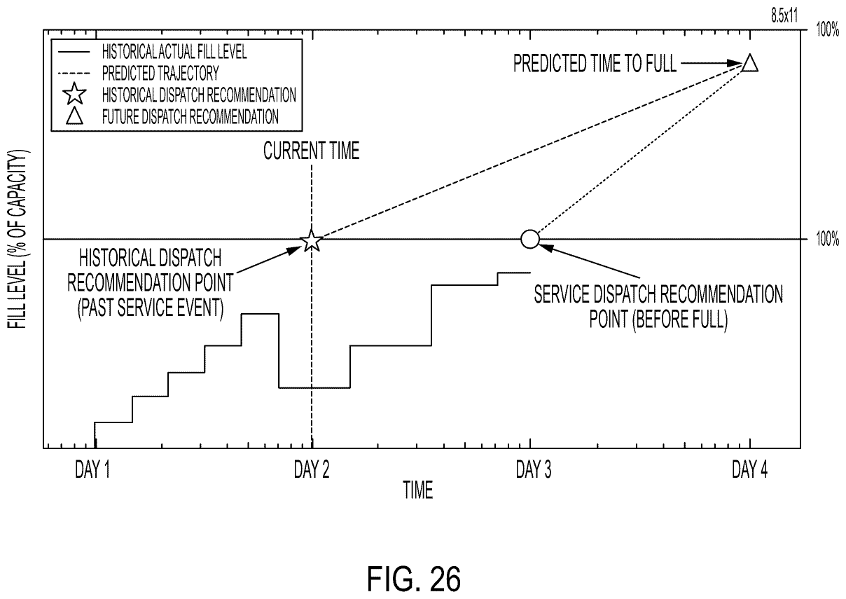

### FIG. 26

Illustrative graph showing example fill level prediction with historical actual fill levels, predicted trajectory, and service dispatch recommendation point.

While preferred embodiments of the present system have been shown and described herein, it will be obvious to those skilled in the art that such embodiments are provided by way of example only. Numerous variations, changes, and substitutions will now occur to those skilled in the art without departing from the system. It should be understood that various alternatives to the embodiments of the system described herein may be employed in practicing the system. It is intended that the following claims define the scope of the system and that methods and structures within the scope of these claims and their equivalents be covered thereby.

What is claimed is:

1. A computer-implemented system for monitoring and diagnosing waste compaction equipment comprising:
a digital processing device comprising a processor, an operating system configured to perform executable instructions, and a memory device;
a computer program stored in the memory device and including instructions executable by the processor to create a monitoring and diagnostic application comprising:
a sensor data acquisition module configured to receive, via a network interface, real-time sensor data from a waste compaction system, said sensor data comprising: hydraulic pressure measurements from pressure sensors monitoring a hydraulic ram actuator, electrical current measurements from current sensors monitoring motors and actuators, temperature measurements from thermal sensors, door position data from door position sensors, weight measurements from weight sensors, fill level measurements from fill level sensors, and video data from cameras;
a hydraulic system diagnostic module configured to:
analyze hydraulic pressure patterns over multiple compaction cycles by extracting statistical metrics for each compaction cycle comprising: maximum pressure, mean pressure, pressure variance, and pressure rise rate;
calculate baseline statistical values for said statistical metrics during a baseline establishment period;
detect pressure anomalies by comparing current cycle statistical metrics to the baseline statistical values;
identify hydraulic system faults selected from the group consisting of: hydraulic fluid leaks indicated by declining maximum pressure over time, pump degradation indicated by reduced pressure rise rate, cylinder seal wear indicated by increased pressure variance, and hydraulic line blockages indicated by abnormally high maximum pressure;
an electrical system diagnostic module configured to:
monitor electrical current draw of motors and actuators during operation;
detect electrical anomalies by comparing current measurements to expected current ranges for specific operations;
identify electrical system faults selected from the group consisting of: motor bearing wear indicated by increased current draw, electrical connection issues indicated by current fluctuations, and actuator mechanical binding indicated by elevated current during actuation;
a predictive maintenance module configured to:
track cumulative cycle counts for mechanical components;
extrapolate degradation trends from historical sensor and real-time data to generate maintenance timing signals consumed by the system to initiate maintenance actions or modify operating parameters of the waste compaction system;
calculate remaining useful life estimates for components based on degradation trends and failure thresholds; and
generate predictive maintenance recommendations specifying components requiring service and estimated time until failure;
wherein the recommendations are used to generate control outputs that at least one of: (i) adjust hydraulic or electrical operating limits of the waste compaction system, (ii) schedule maintenance activities, or (iii) transition the system between operational states including normal, reduced-capacity, and out-of-service modes;
a notification generation module configured to:
evaluate sensor data, diagnostic results, and predictive maintenance recommendations against predefined alert criteria;
generate alert notifications when alert criteria are met, said alert notifications comprising fault descriptions, severity levels, affected components, recommended actions, and timestamps;
transmit alert notifications to operator devices via communication channels selected from the group consisting of: email, SMS, push notifications to mobile applications, and automated phone calls; and
a data storage module configured to store sensor data, diagnostic results, predictive maintenance recommendations, and alert notifications in a database for historical analysis and reporting;
wherein the monitoring and diagnostic application continuously processes real-time sensor data; and
wherein the monitoring and diagnostic application automatically generates maintenance control outputs used to initiate servicing actions or modify operational states of the waste compaction equipment, thereby reducing unplanned downtime.

2. The system of claim 1, wherein the hydraulic system diagnostic module is further configured to:
perform linear regression on maximum pressure values over a sliding time window comprising a plurality of recent compaction cycles;
calculate a degradation rate as a slope of the linear regression;
determine that a hydraulic fluid leak exists when the degradation rate is negative and exceeds a threshold leak rate; and
calculate an estimated time until hydraulic pressure becomes insufficient for compaction by extrapolating the linear regression to a failure pressure threshold.

3. The system of claim 1, wherein extracting statistical metrics for each compaction cycle comprises:
identifying a ram extension phase during which hydraulic pressure rises from baseline to maximum;
calculating pressure rise rate as a maximum rate of pressure increase during the ram extension phase;
identifying a compaction phase during which the hydraulic ram compresses waste;
calculating mean pressure and pressure variance during the compaction phase; and
recording maximum pressure as a peak pressure value achieved during the compaction cycle.

4. The system of claim 1, wherein identifying hydraulic system faults comprises:
correlating multiple statistical metrics exhibiting simultaneous anomalies to specific fault conditions;
wherein hydraulic fluid leaks are identified by simultaneous detection of declining maximum pressure and declining pressure rise rate;
wherein pump degradation is identified by detecting declining pressure rise rate without proportional decline in maximum pressure; and
wherein cylinder seal wear is identified by detecting increased pressure variance while maximum pressure remains within baseline ranges.

5. The system of claim 1, wherein the predictive maintenance module is configured to:
select a regression method executed by a processor from the group consisting of: linear regression, polynomial regression, and exponential regression, based on degradation pattern characteristics;
calculate a goodness-of-fit metric indicating how well the regression method executed by a processor models observed degradation; and
assign a confidence level to remaining useful life estimates based on the goodness-of-fit metric and quantity of historical data.

6. The system of claim 1, wherein the predictive maintenance module is configured to:
identify a plurality of components each requiring service with respective remaining useful life estimates;
rank the components by remaining useful life from shortest to longest;
identify components having remaining useful life estimates within a consolidation threshold indicating service can be consolidated into a single maintenance visit;
generate a consolidated maintenance recommendation specifying multiple components to be serviced during a single visit; and
transmit the consolidated maintenance recommendation with estimated total labor hours and parts costs.

7. The system of claim 1, further comprising:
a thermal monitoring module configured to:
receive thermal image data from an infrared thermal imaging camera positioned to view a waste receiving area of the waste compaction system;
identify localized thermal signatures within the thermal image data exhibiting temperatures exceeding a temperature threshold;
track thermal signatures across sequential thermal images over time;
classify thermal signatures as transient, persistent, or growing based on temporal persistence and spatial or thermal growth characteristics;
generate hazardous material alerts for thermal signatures classified as persistent or growing; and
transmit control commands to the waste compaction system to disable access control functionality responsive to detecting growing thermal signatures classified as critical.

8. The system of claim 1, further comprising:
a fill level prediction module configured to:
analyze historical transaction records and fill level measurements to extract usage patterns comprising transaction frequency as a function of time of day and day of week;
calculate a current fill rate based on recent fill level changes and recent transaction counts;
adjust the current fill rate based on predicted future usage patterns derived from the usage patterns;
calculate a predicted time to full capacity and automatically transmit a service dispatch command to a waste hauling service provider system when the predicted time is below a dispatch threshold to a waste hauling service provider system.

9. A computer-implemented system for thermal hazard detection in waste handling equipment comprising:
a digital processing device comprising a processor and a memory;
a computer program including instructions executable by the processor to create a thermal monitoring application comprising:
a thermal image acquisition module configured to receive thermal image data from an infrared thermal imaging camera positioned to view a waste receiving area of a waste compaction system;
a thermal signature analysis module configured to:
process the thermal image data to identify localized thermal signatures within the waste receiving area;
calculate temperature values for identified thermal signatures;
compare temperature values to a temperature threshold corresponding to fire hazard conditions;
classify thermal signatures as: normal if temperature values are below the temperature threshold, elevated if temperature values are between the temperature threshold and a critical threshold, or critical if temperature values exceed the critical threshold;
a temporal analysis module configured to:
track thermal signatures across sequential thermal images over time by matching thermal signatures in consecutive images based on spatial proximity;
detect thermal signature persistence when a thermal signature at a specific location persists across a plurality of sequential thermal images for a duration exceeding a time threshold;
detect thermal signature growth when a thermal signature exhibits at least one of: spatial extent increase exceeding a growth threshold, or temperature increase exceeding a thermal growth threshold;
classify thermal events as: transient if thermal signature does not persist beyond the time threshold, persistent if thermal signature persists beyond the time threshold without growth, or growing if thermal signature exhibits growth characteristics;
a hazard alert module configured to:
generate hazardous material alerts when thermal signatures are classified as elevated or critical;
determine alert severity based on thermal signature classification and temporal analysis classification;
transmit hazardous material alerts to monitoring personnel with alert severity, temperature measurements, thermal image data, timestamp, and equipment location; and
a control interface module configured to:
transmit control commands to the waste compaction system responsive to thermal hazard detection;
wherein control commands comprise: disabling access control systems to prevent additional waste deposition when critical thermal signatures are detected, activating fire suppression systems when growing thermal signatures exceed the critical threshold, and activating ventilation systems to reduce heat buildup; and
wherein the thermal monitoring application enables detection and mitigation of fire hazards before ignition occurs.

10. The system of claim 9, wherein the thermal signature analysis module is configured to:
calculate a background temperature representing an average temperature of non-waste regions within the thermal image data;
subtract the background temperature from all pixels in the thermal image data to generate background-subtracted thermal image data;
identify pixels in the background-subtracted thermal image data exceeding a differential temperature threshold;
perform connected component analysis to group adjacent pixels exceeding the differential temperature threshold into contiguous regions representing thermal signatures; and
characterize each thermal signature by: centroid location coordinates, spatial extent area, bounding box dimensions, maximum temperature, mean temperature, and temperature variance.

11. The system of claim 9, wherein detecting thermal signature growth comprises:
calculating a first spatial extent area of a thermal signature in a first thermal image;
calculating a second spatial extent area of the thermal signature in a second thermal image captured at a later time;
determining that spatial growth has occurred when the second spatial extent area exceeds the first spatial extent area by more than a spatial growth percentage threshold;
measuring a first maximum temperature of the thermal signature in the first thermal image;
measuring a second maximum temperature of the thermal signature in the second thermal image;
determining that thermal growth has occurred when a rate of temperature increase from the first maximum temperature to the second maximum temperature exceeds a temperature growth rate threshold; and
classifying the thermal signature as growing when at least one of spatial growth or thermal growth has occurred.

12. The system of claim 9, further comprising:
a user correlation module configured to:
receive transaction records from the waste compaction system, said transaction records comprising timestamps, user identifiers, and payment information;
correlate thermal hazard events with transaction records by matching thermal hazard event timestamps to transaction timestamps within a time matching window;
identify users associated with transactions during which thermal hazards were detected;
store correlations between users and thermal hazard events in a database; and
generate accountability reports identifying users who deposited hazardous materials.

13. The system of claim 9, wherein the control interface module is further configured to:
be responsive to detecting a critical thermal signature with growing characteristics:
transmit an immediate lock command to the waste compaction system preventing door unlocking;
display an out-of-service message on a human-machine interface of the waste compaction system indicating fire hazard condition;
activate fire suppression systems if available at the waste compaction system;
transmit emergency notifications to fire department or emergency services with equipment location and hazard description; and
maintain the waste compaction system in a locked out-of-service state until manual reset by
authorized personnel after confirming hazard mitigation.

14. The system of claim 9, wherein the thermal monitoring application further comprises:
a classification engine implemented by one or more processors and memories and configured to:
perform machine-learning-based classification operations on thermal image data, the classification engine being further configured to:
receive labeled training data comprising thermal images with manually annotated classifications distinguishing hazardous thermal signatures from non-hazardous thermal signatures;
train, using the labeled training data; a convolutional neural network classifier that generates hazard classification outputs supplied to a control subsystem to initiate thermal hazard mitigation control actions for monitored equipment;
apply the trained convolutional neural network classifier to newly acquired thermal image data from one or more thermal imaging sensors to generate predicted hazard classifications for detected thermal signatures; and
generate hazard probability scores representing a likelihood that the detected thermal signatures correspond to fire hazards, the hazard probability scores being provided to the control subsystem to selectively trigger thermal hazard mitigation control actions.

15. A computer-implemented method for predictive fill level management in waste compaction systems comprising:
receiving, by a server computer via a network, operational data from a waste compaction system, said operational data comprising: transaction records indicating timestamps and quantities of waste deposits, fill level sensor measurements indicating current fill level of a compaction chamber, and compaction cycle records indicating timestamps of compaction cycles and resulting fill level reductions;
analyzing, by the server computer, the operational data to calculate operational metrics comprising: average waste deposit rate as a function of time of day and day of week, average compaction ratio achieved by compaction cycles, and receiver box capacity remaining;
extracting, by the server computer, usage patterns from the operational data comprising: identifying peak usage periods when transaction frequency exceeds a threshold, identifying usage trends over multi-day periods, and calculating average waste quantity per transaction;
calculating, by the server computer, a predicted time to full capacity by:
determining a current fill rate based on recent fill level sensor measurements and recent transaction records;
adjusting the current fill rate based on predicted future usage patterns derived from the usage patterns;
dividing the receiver box capacity remaining by the adjusted fill rate to calculate predicted time to full;
generating, by the server computer, a service dispatch recommendation when the predicted time to full capacity is less than a dispatch lead time threshold, said service dispatch recommendation comprising: equipment location coordinates, current fill level percentage, predicted time to full capacity, estimated waste weight, and recommended service window; and
transmitting, by the server computer, the service dispatch recommendation to a waste hauling service provider system;
wherein the method enables proactive scheduling of waste hauling services before equipment reaches full capacity.

16. The method of claim 15, wherein adjusting the current fill rate based on predicted future usage patterns comprises:
determining a current time and a current day of week;
retrieving from the usage patterns an expected transaction rate for upcoming time periods based on historical transaction rates for corresponding times and days;
comparing the expected transaction rate to an average transaction rate used in calculating the current fill rate;
calculating an adjustment multiplier as a ratio of the expected transaction rate to the average transaction rate; and
multiplying the current fill rate by the adjustment multiplier to generate the adjusted fill rate;
wherein the adjusted fill rate accounts for temporal variations in usage patterns improving prediction accuracy.

17. The method of claim 15, further comprising:
receiving, by the server computer, weather forecast data for a geographic location of the waste compaction system;
analyzing historical correlations between weather conditions and transaction rates at the geographic location;
determining that predicted adverse weather conditions are associated with reduced transaction rates based on the historical correlations;
applying a weather adjustment factor reducing the adjusted fill rate when adverse weather conditions are predicted; and
recalculating the predicted time to full capacity using the weather-adjusted fill rate.

18. The method of claim 15, further comprising:
tracking, by the server computer, actual service visit timestamps when waste hauling service is performed;
comparing actual fill levels at service visit timestamps to predicted fill levels calculated by the prediction algorithm;
calculating prediction error as a difference between actual and predicted fill levels;
adjusting prediction method executed by a processors parameters to minimize prediction error over multiple service visits using data-driven optimization techniques and models executed to process sensor data and generate fault indicators that are used by the system to generate control outputs that at least one of: (i) adjust hydraulic or electrical operating limits of the waste compaction system, (ii) schedule maintenance activities, or (iii) transition the system between operational states including normal, reduced-capacity, and out-of-service modes; and
storing updated prediction method parameters for future predictions.

19. The method of claim 15, further comprising:
maintaining, by the server computer, a service history database recording past service visits with timestamps and locations;
analyzing the service history database to identify recurring service patterns for specific equipment or geographic regions;
calculating average time between service visits for each equipment unit;
detecting deviations from average time between service visits indicating changed usage patterns; and
generating alerts when detected deviations exceed a threshold, said alerts prompting investigation of usage pattern changes.

20. The method of claim 15, wherein calculating average compaction ratio comprises:
identifying compaction cycle events from the compaction cycle records;
for each compaction cycle event:
determining a fill level immediately before the compaction cycle;
determining a fill level immediately after the compaction cycle;
calculating a fill level reduction as a difference between fill levels before and after compaction;
calculating a compaction ratio for the cycle as a ratio of fill level before to fill level reduction;
aggregating compaction ratios across multiple compaction cycles;
calculating the average compaction ratio as a mean of aggregated compaction ratios; and
using the average compaction ratio to predict how much capacity will be recovered by future compaction cycles.

21. A non-transitory computer-readable storage medium encoded with a computer program including instructions executable by a processor to create a fleet management system for waste compaction equipment comprising:
a database storing equipment records for a plurality of deployed waste compaction systems, each equipment record comprising: equipment identifier, geographic location coordinates, equipment configuration data, sensor data streams, diagnostic status, and maintenance history;
a map visualization module configured to:
generate a map display showing geographic locations of the plurality of waste compaction systems using mapping APIs;
overlay status indicators on the map display indicating operational status of each waste compaction system using color-coding corresponding to status categories selected from: operational, service needed soon, urgent service required, and offline;
enable user interaction to select individual waste compaction systems on the map display and view detailed status information comprising: real-time sensor data, current alerts, fill level percentage, last communication timestamp, and maintenance history;
a comparative analytics module configured to:
aggregate operational metrics across the plurality of waste compaction systems;
calculate fleet-wide statistics including: average uptime percentage, average revenue per system, average compaction cycles per day, and average time between failures;
identify outlier systems exhibiting metrics deviating from fleet averages by more than a statistical threshold;
generate performance ranking reports ranking waste compaction systems by selected metrics;
a maintenance coordination module configured to:
receive service dispatch recommendations from individual waste compaction systems;
consolidate service dispatch recommendations by geographic proximity to enable efficient routing of service vehicles generating routing control parameters subject to vehicle capacity, equipment availability, and service timing constraints;
generate maintenance technician assignments specifying which technician should service which waste compaction systems based on technician location, availability, and skill qualifications;
transmit maintenance work orders to technician mobile devices including equipment identifiers, locations, diagnostic information, and recommended actions; and
an optimization recommendation module configured to:
analyze geographic distribution of waste compaction systems and transaction volume data;
identify underserved locations where waste compaction systems experience high demand exceeding capacity;
identify candidate locations for additional waste compaction system deployments based on geographic gaps and demographic data; and
generate business intelligence reports for operators regarding fleet performance, expansion opportunities, and optimization recommendations.

22. The storage medium of claim 21, wherein the comparative analytics module is configured to:
for each operational metric, calculate a fleet-wide mean value and a fleet-wide standard deviation;
for each waste compaction system, calculate a z-score for each operational metric representing how many standard deviations the system's metric deviates from the fleet-wide mean;
identify a system as an outlier for a specific metric when the absolute value of the z-score exceeds a threshold value;
generate outlier reports listing outlier systems with metrics deviating significantly from fleet norms;
for each outlier, generate diagnostic hypotheses explaining why the system is an outlier; and
prioritize outliers for investigation based on magnitude of deviation and business impact.

23. The storage medium of claim 21, wherein consolidating service dispatch recommendations by geographic proximity comprises:
organizing service dispatch recommendations into a list with geographic location coordinates;
applying a clustering method executed by a processor to group service dispatch recommendations having location coordinates within a proximity threshold into geographic clusters;
for each geographic cluster:
calculating a cluster centroid representing an average location of all service dispatch recommendations in the cluster;
identifying available service technicians within a maximum travel distance of the cluster centroid;
calculating total estimated service time for all service dispatch recommendations in the cluster;
determining whether a single service visit can address all service dispatch recommendations in the cluster based on available technician time and vehicle capacity;
if consolidation is feasible, generating a consolidated work order specifying all equipment to be serviced during a single multi-stop visit; and
optimizing routing sequence for the multi-stop visit to minimize total travel distance.

24. The storage medium of claim 21, wherein generating maintenance technician assignments comprises:
maintaining a technician database storing for each technician: current location coordinates, schedule availability, skill certifications, assigned territory, and vehicle equipment capacity;
for each service dispatch recommendation, determining required skills based on diagnostic information;
filtering available technicians to identify technicians having required skills and schedule availability during the recommended service window;
for each filtered available technician, calculating travel distance from current location to equipment location;
selecting a technician that minimizes at least one criterion selected from the group consisting of: travel distance, response time, and total service cost;
assigning the service dispatch recommendation to the selected technician by creating a work order record linked to the technician; and
transmitting the work order to the technician's mobile device via push notification, SMS, or email.

25. The storage medium of claim 21, wherein the optimization recommendation module is configured to:
define a geographic grid dividing a service area into cells;
for each grid cell, aggregate transaction volume from all waste compaction systems located within the cell;
calculate transaction density as transactions per unit area or transactions per capita based on population data;
identify high-demand cells where transaction density exceeds an upper threshold;
identify low-demand cells where transaction density is below a lower threshold;
recommend relocating waste compaction systems from low-demand cells to high-demand cells to optimize demand matching;
identify cells without deployed waste compaction systems but adjacent to high-demand cells as candidate expansion locations; and
generate deployment priority rankings for candidate locations based on predicted demand and proximity to existing infrastructure.

26. The storage medium of claim 21, wherein the fleet management system further comprises:
a financial analytics module configured to:
aggregate revenue data from transaction records across all waste compaction systems;
aggregate cost data including: equipment capital costs, maintenance and repair costs, waste hauling costs, communication costs, and software licensing costs;
calculate per-unit financial metrics for each waste compaction system comprising: total revenue, total costs, gross profit, profit margin, and return on investment;
generate profitability reports ranking waste compaction systems by profitability;
identify unprofitable systems where costs exceed revenue;
generate recommendations for unprofitable systems selected from: increasing pricing, reducing service frequency, relocating to higher-demand locations, or decommissioning.

27. A computer-implemented system for comprehensive waste compaction equipment monitoring comprising:
a cloud-based monitoring platform comprising:
a data ingestion service configured to receive sensor data from a plurality of distributed waste compaction systems via network connections;
a time-series database configured to store sensor data with timestamps enabling efficient time-series queries;
a diagnostic processing service configured to execute diagnostic algorithms that process sensor data to generate fault signals used to trigger maintenance alerts or operational control actions;
a predictive analytics service configured to calculate remaining useful life estimates for equipment components based on degradation trends;
a thermal analysis service configured to process thermal image data to detect fire hazards;
a notification service configured to generate and transmit alert notifications via multiple communication channels;
an API service exposing application programming interfaces enabling client applications to query data and control equipment remotely; and
a web application providing user interfaces for fleet monitoring, equipment diagnostics, and remote control.

28. The system of claim 27, wherein the diagnostic processing service implements a plurality of specialized diagnostic modules comprising:
a hydraulic diagnostic module analyzing hydraulic pressure patterns to detect hydraulic system faults;
an electrical diagnostic module analyzing electrical current signatures to detect electrical system faults;
a mechanical diagnostic module analyzing vibration data to detect bearing wear and mechanical issues;
a sensor health diagnostic module verifying sensor functionality and detecting sensor failures; and
a communication diagnostic module monitoring network connectivity and data transmission reliability;
wherein each specialized diagnostic module operates independently and generates diagnostic reports specific to its subsystem.

29. The system of claim 27, further comprising:
a data-driven optimization pipeline configured to:
extract features from historical sensor data including statistical metrics, frequency domain features, and time-domain features;
deploy trained models to generate fault prediction outputs,
wherein the fault prediction outputs are automatically consumed by the system to generate maintenance work orders, disable operation of affected equipment, or adjust operating parameters of the waste compaction system.

30. The system of claim 27, wherein the cloud-based monitoring platform further comprises:
a data retention policy manager configured to:
store high-resolution sensor data for a short-term retention period;
down-sample high-resolution sensor data to lower resolution summary statistics after the short-term retention period;
store down-sampled data for a medium-term retention period;
archive down-sampled data to long-term cold storage after the medium-term retention period; and
automatically delete archived data after exceeding a maximum retention period;
wherein the data retention policy manager balances data availability for analysis with storage costs.
